(19) United States
(12) Patent Application Publication
(10) Pub. No.: US 2026/0367314 A1
(43) Pub. Date: Nov. 19, 2026

(54) RIB WAVEGUIDE WITH OPTICAL CROSSTALK ELIMINATED

(71) Applicant: Korea Advanced Institute of Science and Technology, Daejeon (KR)

(72) Inventors: Sangsik KIM, Daejeon (KR); KyungTae KIM, Daejeon (KR); Yosep SHIN, Daejeon (KR)

(21) Appl. No.: 19/678,245

(22) Filed: May 15, 2026

(30) Foreign Application Priority Data
May 15, 2025 (KR) 10-2025-0062908
Feb. 12, 2026 (KR) 10-2026-0028952

(51) Int. Cl. G02B 6/122; G02B 6/12

(52) U.S. Cl. CPC G02B 6/122; G02B 2006/12061; G02B 2006/12097; G02B 2006/12147

(57) ABSTRACT

A rib waveguide with eliminated optical crosstalk includes a plurality of optical waveguides spaced apart from each other and configured to allow light to pass therethrough; and a coupling region including a space between each waveguide and an adjacent waveguide to the each waveguide, wherein, when the light passes through the plurality of optical waveguides, electric fields formed by the plurality of optical waveguides overlap in the coupling region, wherein, in the coupling region, an electric field component in a propagation direction of the light is greater than that of a magnitude of a magnetic field component in the propagation direction, and the overlapped electric fields are formed such that magnitude of an electric field component in a horizontal direction which is a spacing direction between adjacent optical waveguides, is smaller than magnitude of electric field components in the propagation direction.

### CROSS-REFERENCE TO RELATED APPLICATIONS

This application claims priority from Korean Patent Application No. 10-2025-0062908, filed on May 15, 2025, and Korean Patent Application No. 10-2026-0028952, filed on Feb. 12, 2026, in the Korean Intellectual Property Office, each of which is incorporated herein by reference in its entirety.

### TECHNICAL FIELD

The present disclosure relates to a rib waveguide with eliminated optical crosstalk.

### BACKGROUND OF THE INVENTION

Generally, in a photonic integrated circuit (PIC), an optical waveguide is a core component transmitting light to a desired path similar to wiring of an electronic circuit, performing functions of propagation, branching, coupling, and modulation of optical signals. There exist many cases where such optical waveguides are disposed adjacent to each other to implement highly integrated optical devices.

When the optical waveguides are disposed adjacent to each other in this way, an electromagnetic field of light propagating along each optical waveguide penetrates into an adjacent optical waveguide, and optical coupling between the optical waveguides may occur. Such optical coupling induces energy transfer between the optical waveguides, thereby causing optical crosstalk, and as a result, signal distortion and data errors may occur.

Conventionally, in order to reduce such optical crosstalk, methods of increasing a distance between the optical waveguides, adding an insulating medium between the optical waveguides, inserting an optical grating or a photonic crystal structure, or changing a structural shape of the optical waveguide to suppress an expansion of an evanescent field have been used.

However, the method of increasing the distance between the optical waveguides has a limitation of degrading an integration degree of the Photonic Integrated Circuit, and the method of adding the insulating medium or the optical grating structure complicates a manufacturing process and has a limitation of being effective typically under specific wavelength conditions.

Meanwhile, the optical coupling between the optical waveguides is governed not simply by the distance between the optical waveguides, but by a coupling coefficient determined by an electromagnetic field distribution and vertical components of a propagating optical mode. Respective directional components of the electric field and a magnetic field make different contributions to coupling between the optical waveguides, and overall coupling characteristics are determined by magnitudes and signs of the directional components.

Therefore, based on an interaction and a cancellation characteristic among the directional components of the coupling coefficient, there is a need for a rib waveguide with eliminated optical crosstalk to effectively control the optical crosstalk while maintaining a high integration degree in the photonic integrated circuit.

### SUMMARY OF THE INVENTION

Embodiments of the present disclosure provide a rib waveguide with eliminated optical crosstalk to substantially eliminate optical crosstalk between optical waveguides by controlling an electromagnetic field distribution of a coupling region formed between a plurality of optical waveguides in a TM0 mode.

Furthermore, embodiments of the present disclosure provide a rib waveguide with eliminated optical crosstalk to generate a condition where a total coupling coefficient κ converges to 0 by inducing an x-direction coupling coefficient κₓ and a z-direction coupling coefficient κ_{z} among directional coupling coefficients of an electromagnetic field to have negative values by manipulating at least one of variables including a thickness of a slab and a width of a rib.

Furthermore, embodiments of the present disclosure provide a rib waveguide with eliminated optical crosstalk having the total coupling coefficient κ of 0, thereby preventing an occurrence of optical energy transfer between adjacent optical waveguides.

Furthermore, embodiments of the present disclosure provide a rib waveguide with eliminated optical crosstalk enabling stable signal propagation even in an environment with highly integrated optical waveguides since the optical crosstalk is eliminated without increasing a distance between optical waveguides.

Furthermore, embodiments of the present disclosure provide a rib waveguide with eliminated optical crosstalk to apply existing semiconductor processes as they are, preventing an increase in complexity of a manufacturing process, and reducing manufacturing costs by calculating a cancellation condition of the coupling coefficient using the thickness of the slab and the width of the rib as variables while maintaining a structure of the optical waveguide.

Furthermore, embodiments of the present disclosure provide a rib waveguide with eliminated optical crosstalk maintaining a state where the total coupling coefficient κ converges to 0 even when a process variation or a wavelength change exists, thereby maintaining an optical crosstalk suppression performance even in a broadband wavelength range, by defining a relation among the thickness of the slab, the width of the rib, and the distance between the optical waveguides.

An embodiment of the present disclosure is invented focusing on the above background, and provides
a rib waveguide with eliminated optical crosstalk, including a plurality of optical waveguides spaced apart from each other and configured to allow light to pass therethrough; and a coupling region including a space between each waveguide and an adjacent waveguide to the each waveguide, wherein, when the light passes through the plurality of optical waveguides, electric fields formed by the plurality of optical waveguides overlap in the coupling region, wherein, in the coupling region, an electric field component in a propagation direction of the light is greater than that of a magnitude of a magnetic field component in the propagation direction, and the overlapped electric fields are formed such that magnitude of an electric field component in a horizontal direction which is a spacing direction between adjacent optical waveguides, is smaller than magnitude of electric field components in the propagation direction and in a vertical direction perpendicular to the propagation direction and the horizontal direction.

Furthermore, embodiments provide a rib waveguide with eliminated optical crosstalk having a TE fraction defined as the electric field component in the horizontal direction and the electric field component in the vertical direction where no overlap of electric fields occurs for each of the plurality of optical waveguides, ranges from 6% to 20%.

Furthermore, embodiments provide a rib waveguide with eliminated optical crosstalk having the TE fraction of the coupling region calculated based on Equation 1 below,

$$\frac{\int {\vert Ex \vert}^{2} d x d y}{\int ( {\vert Ex \vert}^{2} + {\vert Ey \vert}^{2} ) d x d y} \times 100 \qquad [ Equation 1 ]$$

(Here, Ex is a magnitude of the horizontal electric field, and Ey is a magnitude of the vertical electric field.)

Furthermore, embodiments provide a rib waveguide with eliminated optical crosstalk having a coupling coefficient κₓ in the horizontal direction in the coupling region and a coupling coefficient κ_{z} in the propagation direction in the coupling region are defined by the following Equation 2 and Equation 3, respectively, and the coupling coefficient κₓ and the coupling coefficient κ_{z} each have a negative value,

$${κ}_{x} = \frac{ω {ε}_{0}}{4} \int \int Δ {ε}_{x} ( x , y ) {E}_{1 x} ( x , y ) {E}_{2 x}^{*} ( x , y ) dxdy \qquad [ Equation 2 ]$$

$${κ}_{z} = \frac{ω {ε}_{0}}{4} \int \int Δ {ε}_{z} ( x , y ) {E}_{1 z} ( x , y ) {E}_{2 z}^{*} ( x , y ) d x d y \qquad [ Equation 3 ]$$

(Here, ω is an angular frequency, ε₀ is a free-space permittivity, Δεₓ is a variation in horizontal permittivity, Δε_{z} is a variation in propagation-direction permittivity, E₁ₓ(x,y) is a horizontal electric field in a first optical waveguide of the plurality of optical waveguides,

$${E}_{2 x}^{*} ( x , y )$$

is a horizontal electric field in a second optical waveguide of the plurality of optical waveguides, E_{1z}(x,y) is a propagation-direction electric field in the first optical waveguide, and

$${E}_{2 z}^{*} ( x , y )$$

is a propagation-direction electric field in the second optical waveguide.)

Furthermore, embodiments provide a rib waveguide with eliminated optical crosstalk having a coupling coefficient κ_{y} in the vertical direction in the coupling region is calculated based on the following Equation 4 below.

$${κ}_{y} = \frac{ω {ε}_{0}}{4} \int \int Δ {ε}_{y} ( x , y ) {E}_{1 y} ( x , y ) {E}_{2 y}^{*} ( x , y ) d x d y \qquad [ Equation 4 ]$$

(Here, ω is an angular frequency, ε₀ is a free-space permittivity, Δε_{y} is a variation in vertical permittivity, E_{1y}(x,y) is a vertical electric field in the first optical waveguide, and

$${E}_{2 y}^{*} ( x , y )$$

is a vertical electric field in the second optical waveguide.)

Furthermore, embodiments provide a rib waveguide with eliminated optical crosstalk having a coupling coefficient κ is defined by the following Equation 5, and the coupling coefficient κ is equal to zero.

κ=κₓ+κ_{y}+κ_{z} [Equation 5]

Furthermore, embodiments provide a rib waveguide with eliminated optical crosstalk, wherein the plurality of optical waveguides include a slab and a rib disposed on the slab, wherein the plurality of optical waveguides are configured such that light incident from an outside passes through the slab and the rib.

Furthermore, embodiments provide a rib waveguide with eliminated optical crosstalk having the slab and the rib comprise different compositions.

Furthermore, embodiments provide a rib waveguide with eliminated optical crosstalk having the thickness of the slab and the width of the rib in the coupling region defined by Equation 6 to Equation 8 below.

$${{a}_{1} ( x - {b}_{1} )}^{2} + {c}_{1} < y < {{a}_{2} ( x - {b}_{2} )}^{2} + {c}_{2} \qquad [ Equation 6 ]$$

$$x = \frac{w}{h} \qquad [ Equation 7 ]$$

$$y = \frac{d}{h} \qquad [ Equation 8 ]$$

(Here, w denotes the width of the rib, d denotes the thickness of the slab, h denotes a longest distance between the rib and the slab, a1, b1, and c1 are constants derived from a lower limit value in a corresponding graph of the x and the y in the coupling region, and a2, b2, and c2 are constants calculated derived from an upper limit value in the corresponding graph of the x and the y in the coupling region.)

Furthermore, embodiments provide a rib waveguide with eliminated optical crosstalk wherein, when the plurality of optical waveguides comprise Si and do not comprise N, h ranges from 200 nm to 500 nm, and a wavelength λ ranges from 1.26 μm to 1.57 μm, the ai, bi, and ci are defined by the following Equation 9 to Equation 14, where i is 1 or 2.

(4.2804h²−3.6797h+0.5614)(−0.3445λ+1.5113)≤a₁(h,λ)≤(7.0208h²−5.1314h+0.7089)×(−0.5667λ+1.7174) [Equation 9]

(35.5586h³−36.9382h²+12.1634h+0.4430)(0.0506λ+0.9230)≤b₁(h,λ)≤(128.7664h³−114.7514h²+33.0248h−1.3520)×(0.0901λ+0.8818) [Equation 10]

(1.7963h−0.2547)(−0.8504λ+2.3095)≤c₁(h,λ)≤(2.5457h−0.3920)×(−1.1815λ+2.5474) [Equation 11]

(4.2752h²−3.5308h+0.4708)(−0.2579λ+1.3778)≤a₂≤(6.7254h²−4.7925h+0.6050)(−0.4341λ+1.5464) [Equation 12]

(−37.5193h³+46.8087h²−18.7112h+4.1050)(0.0301λ+0.9532)≤b₂(h,λ)≤(−63.9613h³+69.8611h²−24.4022h+4.4343)×(0.0535λ+0.9293) [Equation 13]

(1.5980h−0.1156)(−0.6698λ+2.0303)≤c₂(h,λ)≤(2.3348h−0.2711)×(−0.9655λ+2.2636) [Equation 14]

Furthermore, embodiments provide a rib waveguide with eliminated optical crosstalk wherein, when the plurality of optical waveguides comprise Si and do not comprise N, h ranges from 250 nm to 500 nm, and a wavelength λ ranges from 1.53 μm to 1.57 μm, the ai, bi, and ci are defined by the following Equation 15 to Equation 20, where i is 1 or 2.

a₁(h,λ)=(4.2804h²−3.6797h+0.5614)(−0.3445λ+1.5113) [Equation 15]

b₁(h,λ)=(35.5586h³−36.9382h²+12.1634h+0.4430)(0.0506λ+0.9230) [Equation 16]

c₁(h,λ)=(1.7963h−0.2547)(−0.8504λ+2.3095) [Equation 17]

a₂(h,λ)=(4.2752h²−3.5308h+0.4708)(−0.2579λ+1.3778) [Equation 18]

b₂(h,λ)=(−37.5193h³+46.8087h²−18.7112h+4.1050)(0.0301λ+0.9532) [Equation 19]

c₂(h,λ)=(1.5980h−0.1156)(−0.6698λ+2.0303) [Equation 20]

Furthermore, embodiments provide a rib waveguide with eliminated optical crosstalk wherein, when the plurality of optical waveguides comprise Si and do not comprise N, h ranges from 200 nm to 400 nm, and a range of a wavelength λ ranges from 1.26 μm to 1.36 μm, the ai, bi, and ci are defined by the following Equation 21 to Equation 26, where i is 1 or 2.

a₁(h,λ)=(7.0208h²−5.1314h+0.7089)×(−0.5667λ+1.7174) [Equation 21]

b₁(h,λ)=(128.7664h³−114.7514h²+33.0248h−1.3520)×(0.0901λ+0.8818) [Equation 22]

c₁(h,λ)=(2.5457h−0.3920)×(−1.1815λ+2.5474) [Equation 23]

a₂=(6.7254h²−4.7925h+0.6050)(−0.4341λ+1.5464) [Equation 24]

b₂(h,λ)=(−63.9613h³+69.8611h²−24.4022h+4.4343)×(0.0535λ+0.9293) [Equation 25]

c₂(h,λ)=(2.3348h−0.2711)×(−0.9655λ+2.2636) [Equation 26]

Furthermore, embodiments provide a rib waveguide with eliminated optical crosstalk wherein, when the plurality of optical waveguides comprise at least one of Li, Nb, or O, h ranges from 150 nm to 500 nm, and a wavelength λ ranges from 0.765 μm to 1.57 μm, the ai, bi, and ci are defined by the following Equation 27 to Equation 32, where i is 1 or 2.

(4.0903h²−1.5939h+0.0934)×(0.0310λ+0.9725)≤a₁(h,λ)≤(2.9703h²−2.3222h+0.3705)×(−0.4970λ+1.7703) [Equation 27]

(0h³+144.7256h²−56.2606h+7.8288)×(−0.4214λ+1.3297)≤b₁(h,λ)≤(0h³+23.9640h²−20.0347h+6.666)×(−0.1845λ+1.2861) [Equation 28]

(3.0411h−0.0604)×(−1.6718λ+2.3044)≤c₁(h,λ)≤(1.3111h+0.0125)×(−0.7034λ+2.0905) [Equation 29]

(6.1017h²−2.3528h+0.1599)×(0.6877λ+0.4574)≤a₂≤(3.7048h²−2.8283h+0.4455)×(−0.2401λ+1.3694) [Equation 30]

(0h³+143.3224h²−56.2086h+8.0672)×(−0.4138λ+1.3242)≤b₂(h,λ)≤(0h³+26.4708h²−22.3673h+7.4035)×(−0.0798λ+1.1237) [Equation 31]

(3.0010h−0.0060)×(−1.4116λ+2.1009)≤c₂(h,λ)≤(1.2941h+0.0668)×(−0.6424λ+1.9957) [Equation 32]

Furthermore, embodiments provide a rib waveguide with eliminated optical crosstalk wherein, when the plurality of optical waveguides comprise at least one of Li, Nb, or O, h ranges from 300 nm to 500 nm, and a wavelength λ ranges from 1.53 μm to 1.57 μm, the ai, bi, and ci are defined by the following Equation 33 to Equations 38, where i is 1 or 2.

a₁(h,λ)=(2.9703h²−2.3222h+0.3705)×(−0.4970λ+1.7703) [Equation 33]

b₁(h,λ)=(0h³+23.9640h²−20.0347h+6.666)×(−0.1845λ+1.2861) [Equation 34]

c₁(h,λ)=(1.3111h+0.0125)×(−0.7034λ+2.0905) [Equation 35]

a₂=(3.7048h²−2.8283h+0.4455)×(−0.2401λ+1.3694) [Equation 36]

b₂(h,λ)=(0h³+26.4708h²−22.3673h+7.4035)×(−0.0798λ+1.1237) [Equation 37]

c₂(h,λ)=(1.2941h+0.0668)×(−0.6424λ+1.9957) [Equation 38]

Furthermore, embodiments provide a rib waveguide with eliminated optical crosstalk wherein, when the plurality of optical waveguides comprise at least one of Li, Nb, or O, h ranges from 300 nm to 400 nm, and a wavelength λ ranges from 1.26 μm to 1.36 μm, the ai, bi, and ci are defined by the following Equation 39 to Equation 44, where i is 1 or 2.

a₁(h,λ)=(7.7562h²−5.3140h+0.8223)×(−0.5333λ+1.6978) [Equation 39]

b₁(h,λ)=(0h³−4.7840h²+3.5586h+1.8041)×(−0.2813λ+1.3706) [Equation 40]

c₁(h,λ)=(1.7453h−0.0584)×(−0.9183λ+2.2043) [Equation 41]

a₂(h,λ)=(9.1378h²−6.1766h+0.9451)×(−0.3027λ+1.3938) [Equation 42]

b₂(h,λ)=(0h³−5.9328h²+3.6708h+2.0987)×(−0.2055λ+1.2709) [Equation 43]

c₂(h,λ)=(1.6740h+0.0197)×(−0.8012λ+2.0505) [Equation 44]

Furthermore, embodiments provide a rib waveguide with eliminated optical crosstalk wherein when the plurality of optical waveguides comprise at least one of Li, Nb, or O, h ranges from 150 nm to 250 nm, and a wavelength λ ranges from 0.765 μm to 0.795 μm, the ai, bi, and ci are defined by the following Equation 45 to Equation 50 where i is 1 or 2.

a₁(h,λ)=(4.0903h²−1.5939h+0.0934)×(0.0310λ+0.9725) [Equation 45]

b₁(h,λ)=(0h³+144.7256h²−56.2606h+7.8288)×(−0.4214λ+1.3297) [Equation 46]

c₁(h,λ)=(3.0411h−0.0604)×(−1.6718λ+2.3044) [Equation 47]

a₂(h,λ)=(6.1017h²−2.3528h+0.1599)×(0.6877λ+0.4574) [Equation 48]

b₂(h,λ)=(0h³+143.3224h²−56.2086h+8.0672)×(−0.4138λ+1.3242) [Equation 49]

c₂(h,λ)=(3.0010h−0.0060)×(−1.4116λ+2.1009) [Equation 50]

Furthermore, embodiments provide a rib waveguide with eliminated optical crosstalk wherein when the plurality of optical waveguides comprise Si and N, h ranges from 200 nm to 600 nm, and a wavelength λ ranges from 0.76 μm to 1.57 μm, the ai, bi, and ci are defined by the following Equation 51 to Equation 56, where i is 1 or 2.

(0.9402h²−0.7537h+0.0459)×(−1.8027λ+2.4099)≤a₁(h,λ)≤(0.4882h²−0.6022h+0.1045)×(−0.7325λ+2.1352) [Equation 51]

(0h³+43.7154h²−26.5812h+6.3494)×(0.6160λ+0.5205)≤b₁(h,λ)≤(−54.3454h³+93.7517h²−55.2117h+13.3936)×(0.4589λ+0.2888) [Equation 52]

(1.1096h+0.2540)×(−0.6370λ+1.4969)≤c₁(h,λ)≤(0.5449h+0.2648)×(−0.3130λ+1.4852) [Equation 53]

(1.8940h²−1.2744h+0.1025)×(−2.3004λ+2.8001)≤a₂≤(0.7324h²−0.8781h+0.1751)×(−0.8580λ+2.3306) [Equation 54]

(0h³+40.1460h²−25.0287h+6.3345)×(0.5239λ+0.5927)≤b₂(h,λ)≤(−71.7281h³+121.2376h²−69.7364h+16.0803)×(0.5047λ+0.2177) [Equation 55]

(1.1140h+0.2798)×(−0.6273λ+1.4892)≤c₂(h,λ)≤(0.5688h+0.2779)×(−0.3019λ+1.4680) [Equation 56]

Furthermore, embodiments provide a rib waveguide with eliminated optical crosstalk, wherein, when the plurality of optical waveguides comprise Si and N, h ranges from 350 nm to 600 nm, and a wavelength λ ranges from 1.53 μm to 1.57 μm, the ai, bi, and ci are defined by the following Equation 57 to Equation 62, where i is 1 or 2.

a₁(h,λ)=(0.4882h²−0.6022h+0.1045)×(−0.7325λ+2.1352) [Equation 57]

b₁(h,λ)=(−54.3454h³+93.7517h²−55.2117h+13.3936)×(0.4589λ+0.2888) [Equation 58]

c₁(h,λ)=(0.5449h+0.2648)×(−0.3130λ+1.4852) [Equation 59]

a₂=(0.7324h²−0.8781h+0.1751)×(−0.8580λ+2.3306) [Equation 60]

b₂(h,λ)=(−71.7281h³+121.2376h²−69.7364h+16.0803)×(0.5047λ+0.2177) [Equation 61]

c₂(h,λ)=(0.5688h+0.2779)×(−0.3019λ+1.4680) [Equation 62]

Furthermore, embodiments provide a rib waveguide with eliminated optical crosstalk wherein when the plurality of optical waveguides comprise Si and N, h ranges from 300 nm to 500 nm, and a wavelength λ ranges from 1.26 μm to 1.36 μm, the ai, bi, and ci are defined by the following Equation 63 to Equation 68, where i is 1 or 2.

a₁(h,λ)=(0.5362h²−0.6056h+0.0826)×(−0.9016λ+2.1835) [Equation 63]

b₁(h,λ)=(−96.4897h³+136.1767h²−66.0737h+13.3296)×(0.4994λ+0.3464) [Equation 64]

c₁(h,λ)=(0.6397h+0.2660)×(−0.3627λ+1.4754) [Equation 65]

a₂=(1.0648h²−1.0616h+0.1691)×(−1.0307λ+2.3510) [Equation 66]

b₂(h,λ)=(−103.5869h³+142.8166h²−68.0991h+13.6835)×(0.4890λ+0.3601) [Equation 67]

c₂(h,λ)=(0.6654h+0.2812)×(−0.3644λ+1.4776) [Equation 68]

Furthermore, embodiments provide a rib waveguide with eliminated optical crosstalk wherein when the plurality of optical waveguides comprise Si and N, h ranges from 200 nm to 300 nm, and a wavelength λ ranges from 0.76 μm to 0.8 μm, the ai, bi, and ci are defined by the following Equation 69 to Equation 74, where i is 1 or 2.

a₁(h,λ)=(0.9402h²−0.7537h+0.0459)×(−1.8027λ+2.4099) [Equation 69]

b₁(h,λ)=(0h³+43.7154h²−26.5812h+6.3494)×(0.6160λ+0.5205) [Equation 70]

c₁(h,λ)=(1.1096h+0.2540)×(−0.6370λ+1.4969) [Equation 71]

a₂(h,λ)=(1.8940h²−1.2744h+0.1025)×(−2.3004λ+2.8001) [Equation 72]

b₂(h,λ)=(0h³+40.1460h²−25.0287h+6.3345)×(0.5239λ+0.5927) [Equation 73]

c₂(h,λ)=(1.1140h+0.2798)×(−0.6273λ+1.4892) [Equation 74]

Furthermore, embodiments provide a rib waveguide with eliminated optical crosstalk wherein when the plurality of optical waveguides comprise at least one of Li, Ta or O, h ranges from 300 nm to 500 nm, and a wavelength λ ranges from 1.26 μm to 1.57 μm, the ai, bi, and ci are defined by the following Equation 75 to Equation 80, where i is 1 or 2.

(−0.5282h²−0.4074h+0.0750)×(−1.6357λ+3.5388)≤a₁(h,λ)≤(7.2287h²−5.5571h+0.9227)×(−1.8058λ+3.3663) [Equation 75]

(6.9131h³+14.9322h²−18.9589h+6.9147)×(0.3166λ+0.5093)≤b₁(h,λ)≤(0h³−11.5154h²+4.2365h+2.0228)×(0.3142λ+0.5885) [Equation 76]

(0.4820h+0.2100)×(−0.2732λ+1.4235)≤c₁(h,λ)≤(0.7150h+0.1745)×(−0.3925λ+1.5146) [Equation 77]

(−0.0867h²−0.8051h+0.1380)×(−1.6950λ+3.6309)≤a₂≤(9.3541h²−7.0438h+1.1602)×(−1.7683λ+3.3174) [Equation 78]

(18.3740h³+1.5265h²−14.1741h+6.5985)×(0.2961λ+0.5413)≤b₂(h,λ)≤(0h³−9.5687h²+2.3057h+2.6414)×(0.3406λ+0.5538) [Equation 79]

(0.6238h+0.2060)×(−0.3070λ+1.4756)≤c₂(h,λ)≤(0.8353h+0.1823)×(−0.4180λ+1.5481) [Equation 80]

Furthermore, embodiments provide a rib waveguide with eliminated optical crosstalk wherein when the plurality of optical waveguides comprise at least one of Li, Ta, or O, h ranges from 300 nm to 500 nm, and a wavelength λ ranges from 1.53 μm to 1.57 μm, the ai, bi, and ci are calculated based on the following Equation 81 to Equation 86, where i is 1 or 2.

a₁(h,λ)=(−0.5282h²−0.4074h+0.0750)×(−1.6357λ+3.5388) [Equation 81]

b₁(h,λ)=(6.9131h³+14.9322h²−18.9589h+6.9147)×(0.3166λ+0.5093) [Equation 82]

c₁(h,λ)=(0.4820h+0.2100)×(−0.2732λ+1.4235) [Equation 83]

a₂(h,λ)=(−0.0867h²−0.8051h+0.1380)×(−1.6950λ+3.6309) [Equation 84]

b₂(h,λ)=(18.3740h³+1.5265h²−14.1741h+6.5985)×(0.2961λ+0.5413) [Equation 85]

c₂(h,λ)=(0.6238h+0.2060)×(−0.3070λ+1.4756) [Equation 86]

Furthermore, embodiments provide a rib waveguide with eliminated optical crosstalk wherein when the plurality of optical waveguides comprise at least one of Li, Ta or O, h ranges from 300 nm to 400 nm, and a wavelength λ ranges from 1.26 μm to 1.36 μm, the ai, bi, and ci are defined by the following Equation 87 to Equation 92, where i is 1 or 2.

a₁(h,λ)=(7.2287h²−5.5571h+0.9227)×(−1.8058λ+3.3663) [Equation 87]

b₁(h,λ)=(0h³−11.5154h²+4.2365h+2.0228)×(0.3142λ+0.5885) [Equation 88]

c₁(h,λ)=(0.7150h+0.1745)×(−0.3925λ+1.5146) [Equation 89]

a₂=(9.3541h²−7.0438h+1.1602)×(−1.7683λ+3.3174) [Equation 90]

b₂(h,λ)=(0h³−9.5687h²+2.3057h+2.6414)×(0.3406λ+0.5538) [Equation 91]

c₂(h,λ)=(0.8353h+0.1823)×(−0.4180λ+1.5481) [Equation 92]

Furthermore, embodiments provide a rib waveguide with eliminated optical crosstalk wherein when the plurality of optical waveguides comprise at least one of Ba, Ti, or O, h ranges from 200 nm to 500 nm, and a wavelength λ ranges from 1.26 μm to 1.57 μm, the ai, bi, and ci are defined by the following Equation 93 to Equation 98, where i is 1 or 2.

(−0.5113h²−0.0697h+0.0026)×(−2.0302λ+4.1441)≤a₁(h,λ)≤(12.2501h²−9.1733h+1.5302)×(−1.8778λ+3.4656) [Equation 93]

(0h³−20.2498h²−18.8865h+6.2122)×(0.1569λ+0.7563)≤b₁(h,λ)≤(0h³−23.5823h²+13.5943h+0.1429)×(0.1419λ+0.8156) [Equation 94]

(0.6112h+0.1533)×(−0.3951λ+1.6125)≤c₁(h,λ)≤(0.8689h+0.0973)×(−0.4900λ+1.6421) [Equation 95]

(0.2377h²−0.7678h+0.1315)×(−1.4150λ+3.1953)≤a₂≤(15.8959h²−11.6936h+1.9322)×(−1.7315λ+3.2714) [Equation 96]

(0h³+18.4494h²−17.7013h+6.2640)×(0.3303λ+0.4886)≤b₂(h,λ)≤(0h³−21.7569h²+11.7518h+0.7363)×(0.2032λ+0.7351) [Equation 97]

(0.7126h+0.1641)×(−0.4156λ+1.6441)≤c₂(h,λ)≤(0.9799h+0.1199)×(−0.4912λ+1.6435) [Equation 98]

Furthermore, embodiments provide a rib waveguide with eliminated optical crosstalk wherein when the plurality of optical waveguides comprise at least one of Ba, Ti, or O, h ranges from 300 nm to 500 nm, and a wavelength λ ranges from 1.53 μm to 1.57 μm, the ai, bi, and ci are defined by the following Equation 99 to Equation 104, where i is 1 or 2.

a₁(h,λ)=(−0.5113h²−0.0697h+0.0026)×(−2.0302λ+4.1441) [Equation 99]

b₁(h,λ)=(0h³−20.2498h²−18.8865h+6.2122)×(0.1569λ+0.7563) [Equation 100]

c₁(h,λ)=(0.6112h+0.1533)×(−0.3951λ+1.6125) [Equation 101]

a₂(h,λ)=(0.2377h²−0.7678h+0.1315)×(−1.4150λ+3.1953) [Equation 102]

b₂(h,λ)=(0h³+18.4494h²−17.7013h+6.2640)×(0.3303λ+0.4886) [Equation 103]

c₂(h,λ)=(0.7126h+0.1641)×(−0.4156λ+1.6441) [Equation 104]

Furthermore, embodiments provide a rib waveguide with eliminated optical crosstalk wherein when the plurality of optical waveguides comprise at least one of Ba, Ti, or O, h ranges from 300 nm 400 nm, and a wavelength λ ranges from 1.26 μm to 1.36 μm, the ai, bi, and ci are defined by the following Equation 105 to Equation 110, where i is 1 or 2.

a₁(h,λ)=(12.2501h²−9.1733h+1.5302)×(−1.8778λ+3.4656) [Equation 105]

b₁(h,λ)=(0h³−23.5823h²+13.5943h+0.1429)×(0.1419λ+0.8156) [Equation 106]

c₁(h,λ)=(0.8689h+0.0973)×(−0.4900λ+1.6421) [Equation 107]

a₂=(15.8959h²−11.6936h+1.9322)×(−1.7315λ+3.2714) [Equation 108]

b₂(h,λ)=(0h³−21.7569h²+11.7518h+0.7363)×(0.2032λ+0.7351) [Equation 109]

c₂(h,λ)=(0.9799h+0.1199)×(−0.4912λ+1.6435) [Equation 110]

Embodiments of the present disclosure substantially eliminate optical crosstalk between optical waveguides by controlling an electromagnetic field distribution of a coupling region formed between a plurality of optical waveguides in a TM0 mode.

Furthermore, embodiments of the present disclosure generate a condition where a total coupling coefficient κ becomes 0 by inducing an x-direction coupling coefficient κₓ and a z-direction coupling coefficient κ_{z} among directional coupling coefficients of an electromagnetic field to have negative values by manipulating at least one of variables including a thickness of a slab and a width of a rib.

Furthermore, embodiments of the present disclosure prevent an occurrence of optical energy transfer between adjacent optical waveguides by setting the total coupling coefficient κ to 0.

Furthermore, embodiments of the present disclosure enable stable signal propagation even in an environment with highly integrated optical waveguides since the optical crosstalk is eliminated without increasing a distance between optical waveguides.

Furthermore, embodiments of the present disclosure apply existing semiconductor processes as they are, prevent an increase in complexity of a manufacturing process, and reduce manufacturing costs by calculating a cancellation condition of the coupling coefficient using the thickness of the slab and the width of the rib as variables while maintaining a structure of the optical waveguide.

Furthermore, embodiments of the present disclosure maintain an optical crosstalk suppression performance even in a broadband wavelength range by maintaining a state where the total coupling coefficient κ converges to 0 even when a process variation or a wavelength change exists, by defining a relation among the thickness of the slab, the width of the rib, and the distance between the optical waveguides.

### BRIEF DESCRIPTION OF THE DRAWINGS

FIG. 1 is a perspective view of a rib waveguide with eliminated optical crosstalk according to a first embodiment of the present disclosure.

FIG. 2 is a cross-sectional view taken along line II-II of FIG. 1.

FIG. 3 is a view showing an electric field according to a thickness of a slab in a single optical waveguide in the first embodiment.

FIG. 4 is a view showing a graph displaying a correlation between a width of a rib and a TE fraction in a single optical waveguide in the first embodiment.

FIG. 5 is a conceptual view and graph of a case where the optical crosstalk of FIG. 1 is not eliminated.

FIG. 6 is a conceptual view and graph of a case where the optical crosstalk of FIG. 1 is eliminated.

FIG. 7 is a view showing a graph displaying a TE fraction according to a thickness d of a slab and a width w of a rib versus a longest distance h between the rib and the slab when h ranges from 250 nm to 500 nm, and a wavelength λ ranges from 1.53 μm to 1.57 μm in the first embodiment of FIG. 1.

FIG. 8 is a view showing a graph displaying a TE fraction according to the thickness d of the slab and the width w of the rib versus the longest distance h between the rib and the slab when h ranges from 200 nm to 400 nm, and a range of a wavelength λ is 1.26 μm or more and 1.36 μm in the first embodiment of FIG. 1.

FIG. 9 is a view showing a graph displaying a TE fraction according to the thickness d of the slab and the width w of the rib versus the longest distance h between the rib and the slab when h ranges from 300 nm to 500 nm, and a wavelength λ ranges from 1.53 μm to 1.57 μm in a second embodiment of FIG. 1.

FIG. 10 is a view showing a graph displaying a TE fraction according to the thickness d of the slab and the width w of the rib versus the longest distance h between the rib and the slab when h ranges from 300 nm to 400 nm, and a wavelength λ ranges from 1.26 μm to 1.36 μm in the second embodiment of FIG. 1.

FIG. 11 is a view showing a graph displaying a TE fraction according to the thickness d of the slab and the width w of the rib versus the longest distance h between the rib and the slab when h ranges from 150 nm to 250 nm, and a wavelength λ ranges from 0.765 μm to 0.795 μm in the second embodiment of FIG. 1.

FIG. 12 is a view showing a graph displaying a TE fraction according to the thickness d of the slab and the width w of the rib versus the longest distance h between the rib and the slab when h ranges from 350 nm to 600 nm, and a wavelength λ ranges from 1.53 μm to 1.57 μm in a third embodiment of FIG. 1.

FIG. 13 is a view showing a graph displaying a TE fraction according to the thickness d of the slab and the width w of the rib versus the longest distance h between the rib and the slab when h ranges from 300 nm to 500 nm, and a wavelength λ ranges from 1.26 μm to 1.36 μm in the third embodiment of FIG. 1.

FIG. 14 is a view showing a graph displaying a TE fraction according to the thickness d of the slab and the width w of the rib versus the longest distance h between the rib and the slab when h ranges from 200 nm to 300 nm, and a wavelength λ ranges from 0.76 μm to 0.8 μm in the third embodiment of FIG. 1.

FIG. 15 is a view showing a graph displaying a TE fraction according to the thickness d of the slab and the width w of the rib versus the longest distance h between the rib and the slab when h ranges from 300 nm to 500 nm, and a wavelength λ ranges from 1.53 μm to 1.57 μm in a fourth embodiment of FIG. 1.

FIG. 16 is a view showing a graph displaying a TE fraction according to the thickness d of the slab and the width w of the rib versus the longest distance h between the rib and the slab when h ranges from 300 nm to 400 nm, and a wavelength λ ranges from 1.26 μm to 1.36 μm in the fourth embodiment of FIG. 1.

FIG. 17 is a view showing a graph displaying a TE fraction according to the thickness d of the slab and the width w of the rib versus the longest distance h between the rib and the slab when h ranges from 300 nm to 500 nm, and a wavelength λ ranges from 1.53 μm to 1.57 μm in a fifth embodiment of FIG. 1.

FIG. 18 is a view showing a graph displaying a TE fraction according to the thickness d of the slab and the width w of the rib versus the longest distance h between the rib and the slab when h ranges from 300 nm 400 nm, and a wavelength λ ranges from 1.26 μm to 1.36 μm in the fifth embodiment of FIG. 1.

### DETAILED DESCRIPTION OF THE INVENTION

Hereinafter, specific embodiments for implementing a technical idea of the present disclosure will be described in detail with reference to the drawings.

In addition, in describing the present disclosure, when it is determined that a detailed description of a related known configuration or function obscures a subject matter of the present disclosure, the detailed description thereof will be omitted.

Furthermore, when an element is referred to as being “connected”, “supported”, “supplied”, or “transferred” to another element, the element is to be understood to be directly connected, supported, supplied, or transferred to the other element, but other elements may exist in between.

Terms used in the present specification are used typically to describe specific embodiments and are not intended to limit the present disclosure. Singular expressions include plural expressions unless a context clearly indicates otherwise.

Furthermore, expressions such as upper side, lower side, and side surface in the present specification are clarified in advance to be described based on illustrations in the drawings, and may be expressed differently when a direction of a corresponding object is changed. For the same reason, some elements are exaggerated, omitted, or schematically illustrated in the accompanying drawings, and a size of each element does not entirely reflect an actual size.

Furthermore, terms including ordinal numbers such as first and second may be used to describe various elements, but corresponding elements are not limited by such terms. These terms are used typically for a purpose of distinguishing one element from another element.

A meaning of “including” used in the specification specifies a specific characteristic, region, integer, operation, element, and/or component, and does not exclude a presence or an addition of another specific characteristic, region, integer, operation, element, component, and/or group.

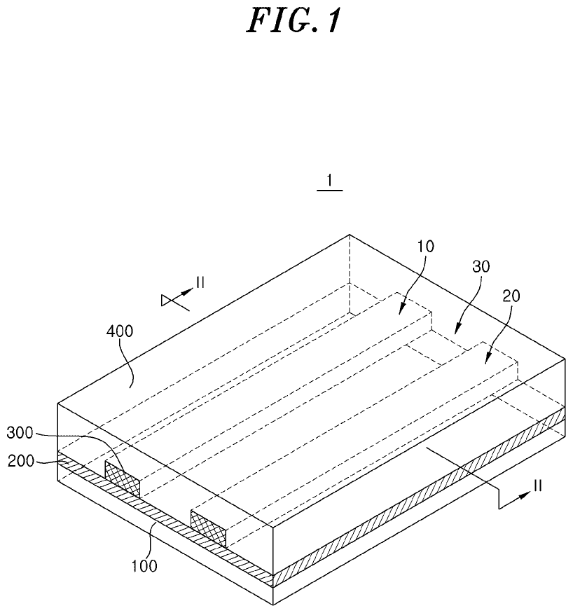

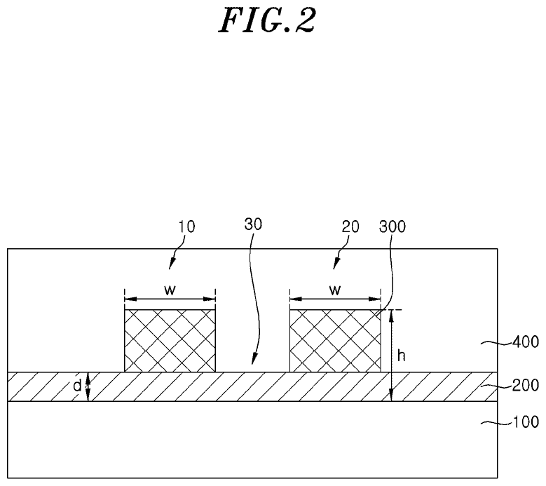

Referring to FIGS. 1 to 6, an optical waveguide assembly 1 according to a first embodiment of the present disclosure may guide light inward and propagate the light along a path when light is irradiated from the outside. Such an optical waveguide assembly 1 may be referred as a rib waveguide with eliminated optical crosstalk. Here, an x direction may be defined as a direction in which a plurality of optical waveguides 10 and 20 described later are arrayed. Furthermore, a z direction may be defined as a propagation direction. Furthermore, a y direction may be defined as a direction in which the plurality of optical waveguides 10 and 20 extend, and a direction perpendicular to the x direction and the z direction. Such an optical waveguide assembly 1 may include the plurality of optical waveguides 10 and 20, and a coupling region 30 may be provided between the plurality of optical waveguides 10 and 20.

The optical waveguides 10 and 20 may be configured to allow light to pass through. The optical waveguides 10 and 20 may be arranged to allow light to pass through and propagate. When light propagates along the optical waveguides 10 and 20, an electric field and a magnetic field may be formed around each of the optical waveguides 10 and 20.

The optical waveguides 10 and 20 may be placed in a TM mode. Here, the TM mode may refer to a mode in which a magnetic field component is mainly formed in a transverse direction when light propagates. In one embodiment, the optical waveguides 10 and 20 may be placed in a TM0 mode when light propagates. Here, the TM0 mode may be defined as a fundamental quasi-transverse magnetic mode in the optical waveguides 10 and 20. In other words, the TM0 mode may be a lowest-order mode in which all six electromagnetic field components of Ex, Ey, Ez and Hx, Hy, Hz exist, but a magnetic field component Hz in the propagation direction is very insignificant compared to a magnetic field component Hx perpendicular to the propagation direction, and minor electric fields Ex and Ez appear together with a main electric field Ey.

The optical waveguides 10 and 20 may be placed such that a vertical electric field Ey is dominant over a horizontal electric field Ex when light propagates. In other words, the optical waveguides 10 and 20 may guide light having a dominant vertical polarization component due to a TM0 mode characteristic when light propagates. Furthermore, in the TM0 mode of the optical waveguides 10 and 20 a TE fraction representing a relative intensity between the vertical electric field Ey and the horizontal electric field Ex may be derived. A plurality of optical waveguides 10 and 20 may be provided.

A plurality of optical waveguides 10 and 20 may be spaced apart from each other. The plurality of optical waveguides 10 and 20 may provide independent light propagation paths. The plurality of optical waveguides 10 and 20 may include a first optical waveguide 10 and a second optical waveguide 20. A coupling region 30 may be formed between the plurality of optical waveguides 10 and 20. In other words, the coupling region 30 may be a space between adjacent ones of the plurality of optical waveguides 10 and 20. When the optical waveguides 10 and 20 are arranged adjacent to each other, electric field distributions of light in the adjacent optical waveguides 10 and 20 may overlap, thereby causing mode coupling.

Meanwhile, the optical waveguide assembly 1 may include a lower cladding 100, a slab 200, a plurality of ribs 300 and an upper cladding 400. Among the plurality of ribs 300, a rib disposed on a side of a first optical waveguide 10 may be referred to as a first rib, and a rib disposed on a side of a second optical waveguide 20 may be referred to as a second rib.

The first rib and a region of the slab 200 adjacent to the first rib may form the first optical waveguide 10 and the second rib and a region of the slab 200 adjacent to the second rib may form the second optical waveguide 20.

Further, the coupling region 30 may include a region between the first rib and the second rib. In other words, the plurality of optical waveguides may include the slab 200 and the plurality of ribs 300. The first optical waveguide among the plurality of optical waveguides may include at least the first rib and a portion of the slab 200, for example, a region adjacent to the first rib, and the second optical waveguide among the plurality of optical waveguides may include at least the second rib and another portion of the slab 200, for example, a region adjacent to the second rib.

The lower cladding 100 may be disposed below the slab 200. The lower cladding 100 may support the slab 200. The lower cladding 100 may include Si. For example, the lower cladding 100 may be SiO₂, but is not limited thereto.

The slab 200 may be disposed above the lower cladding 100. Furthermore, the slab 200 may be disposed below the rib 300. Light irradiated from the outside may pass through and propagate within the slab 200. In other words, light irradiated from the outside may propagate through the slab 200. Such a slab 200 may include Si. Furthermore, the slab 200 may exclude N. For example, the slab 200 may include silicon, but is not limited thereto. The slab 200 may include a component different from a component of the rib 300, but is not limited thereto. A thickness of such a slab 200 is denoted by d in the drawings.

The rib 300 may be disposed on the slab 200. Light irradiated from the outside may pass through and propagate within the rib 300. The rib 300 may be disposed above the slab 200. The rib 300 may include Si. Furthermore, the rib 300 may exclude N. The rib 300 may include a component different from a component of the slab 200, but is not limited thereto. A width of the rib 300 is denoted by w in the drawings. Furthermore, a longest distance between the rib 300 and the slab 200 is denoted by h in the drawings.

The upper cladding 400 may surround at least one of the slab 200 and the rib 300. The upper cladding 400 may be disposed above the slab 200 and the rib 300. The upper cladding 400 may include Si. Furthermore, the upper cladding 400 may exclude N.

Electric fields formed from the adjacent optical waveguides 10 and 20 may spatially overlap in the coupling region 30. In other words, electric field distributions formed by the plurality of optical waveguides 10 and 20 may overlap each other in the coupling region 30. The coupling region 30 may include a space between the plurality of optical waveguides 10 and 20.

When a space through which the plurality of ribs 300 pass in order to be projected onto or brought into contact with each other in a horizontal direction is defined as an intermediate region, the coupling region 30 may include at least the intermediate region. The intermediate region may be a portion of the upper cladding 400. The first rib, the intermediate region, and the second rib may be sequentially arranged in the horizontal direction. The intermediate region may have a width equal to a horizontal separation distance between the first rib and the second rib, and may have a height equal to a thickness of the first rib or the second rib. Since the coupling region 30 includes at least the intermediate region, technical features of the coupling region 30 described below may also be applied to the intermediate region.

The coupling region 30 may include a region adjacent to the plurality of optical waveguides 10 and 20. For example, the coupling region 30 may include a region surrounding the plurality of optical waveguides 10 and 20.

Furthermore, the coupling region 30 may encompass the lower cladding 100, the slab 200, the rib 300, and the upper cladding 400. In other words, the coupling region 30 may be formed in a region surrounding at least one of the lower cladding 100, the slab 200, the rib 300, and the upper cladding 400. In an embodiment, the coupling region 30 may be formed above the slab 200 and the lower cladding 100. In another embodiment, the coupling region 30 may be formed above the rib 300.

The TE fraction may be calculated by an electric field of an uncoupled waveguide mode and the vertical electric field. In other words, the TE fraction may be defined as a ratio of a horizontal electric field to a sum of the horizontal electric field and the vertical electric field in the coupling region 30. The TE fraction in the coupling region 30 may be calculated based on Equation 1.

$$\frac{\int {\vert Ex \vert}^{2} d x d y}{\int ( {\vert Ex \vert}^{2} + {\vert Ey \vert}^{2} ) d x d y} \times 100 \qquad [ Equation 1 ]$$

(Here, Ex is a magnitude of the horizontal electric field, and Ey is a magnitude of the vertical electric field.)

Such a TE fraction of the uncoupled waveguide mode may be 6% or more and 20% or less. In other words, the ratio of the horizontal electric field to the sum of the horizontal electric field and the vertical electric field of the uncoupled waveguide mode may be 6% or more and 20% or less.

A coupling coefficient κ in the coupling region 30 may be calculated by Equation 5 below.

κ=κₓ+κ_{y}+κ_{z} [Equation 5]

Such a coupling coefficient κ in the coupling region 30 may be calculated as a sum of an x-direction coupling coefficient κₓ, a y-direction coupling coefficient κ_{y}, and a z-direction coupling coefficient κ_{z}. The x-direction coupling coefficient κₓ in the coupling region 30 may be calculated based on Equation 2 below.

$${κ}_{x} = \frac{ω {ε}_{0}}{4} \int \int Δ {ε}_{x} ( x , y ) {E}_{1 x} ( x , y ) {E}_{2 x}^{*} ( x , y ) d x d y \qquad Equation 2$$

(Here, ω is an angular frequency, ε₀ is a free-space permittivity, Δεₓ is a variation of horizontal permittivity, E₁ₓ(x,y) is a horizontal electric field in a first optical waveguide 10, and

$${E}_{2 x}^{*} ( x , y )$$

is a horizontal electric field in a second optical waveguide 20.)

Furthermore, the y-direction coupling coefficient κ_{y} in the coupling region 30 may be calculated based on Equation 4 below.

$${κ}_{y} = \frac{ω {ε}_{0}}{4} \int \int Δ {ε}_{y} ( x , y ) {E}_{1 y} ( x , y ) {E}_{2 y}^{*} ( x , y ) d x d y \qquad Equation 4$$

(Here, ω is an angular frequency, ε₀ is a free-space permittivity, Δε_{y} is a variation of vertical permittivity, E_{1y}(x,y) is a vertical electric field in the first optical waveguide 10, and

$${E}_{2 y}^{*} ( x , y )$$

is a vertical electric field in the second optical waveguide 20.)

Furthermore, the z-direction coupling coefficient κ_{z} in the coupling region 30 may be calculated based on Equation 3 below.

$${κ}_{z} = \frac{ω {ε}_{0}}{4} \int \int Δ {ε}_{z} ( x , y ) {E}_{1 z} ( x , y ) {E}_{2 z}^{*} ( x , y ) d x d y \qquad [ Equation 3 ]$$

(Here, ω is an angular frequency, ε₀ is a free-space permittivity Δε_{z} is a variation in propagation-direction permittivity, E_{1z}(x,y) is a propagation-direction electric field in the first optical waveguide 10, and

$${E}_{2 z}^{*} ( x , y )$$

is a propagation-direction electric field in the second optical waveguide 20.)

The x-direction coupling coefficient κₓ and the z-direction coupling coefficient κ_{z} in the coupling region 30 may be negative numbers. Furthermore, an absolute value of the y-direction coupling coefficient κ_{Y} in the coupling region 30 may be equal to or greater than a sum of an absolute value of the x-direction coupling coefficient κₓ and an absolute value of the z-direction coupling coefficient κ_{z}. For example, a sum of the x-direction coupling coefficient κₓ, the y-direction coupling coefficient κ_{y}, and the z-direction coupling coefficient κ_{z} in the coupling region 30 may be 0. In other words, the coupling coefficient κ in the coupling region 30 may be 0.

The thickness d of the slab 200 and the width w of the rib 300 in the coupling region 30 may be determined by Equation 6 to Equation 8 below.

$${{a}_{1} ( x - {b}_{1} )}^{2} + {c}_{1} < y < {{a}_{2} ( x - {b}_{2} )}^{2} + {c}_{2} \qquad [ Equation 6 ]$$

$$x = \frac{w}{h} \qquad [ Equation 7 ]$$

$$y = \frac{d}{h} \qquad [ Equation 8 ]$$

(Here, w denotes the width of the rib 300, d denotes the thickness of the slab 200, h denotes the longest distance between the rib 300 and the slab 200, a1, b1, and c1 are constants calculated based on a lower limit value in a corresponding graph of the x and the y in the coupling region 30, and a2, b2, and c2 are constants calculated based on an upper limit value in the corresponding graph of the x and the y in the coupling region 30.)

In the coupling region 30, when the longest distance h between the rib 300 and the slab 200 ranges from 200 nm to 500 nm, and a wavelength λ of light irradiated from the outside ranges from 1.26 m to 1.57 μm, ai, bi, and ci of Equation 6 may be calculated based on Equation 9 to Equation 14 below. (Here, i is 1 or 2.)

(4.2804h²−3.6797h+0.5614)(−0.3445λ+1.5113)≤a₁(h,λ)≤(7.0208h²−5.1314h+0.7089)×(−0.5667λ+1.7174) [Equation 9]

(35.5586h³−36.9382h²+12.1634h+0.4430)(0.0506λ+0.9230)≤b₁(h,λ)≤(128.7664h³−114.7514h²+33.0248h−1.3520)×(0.0901λ+0.8818) [Equation 10]

(1.7963h−0.2547)(−0.8504λ+2.3095)≤c₁(h,λ)≤(2.5457h−0.3920)×(−1.1815λ+2.5474) [Equation 11]

(4.2752h²−3.5308h+0.4708)(−0.2579λ+1.3778)≤a₂ (6.7254h²−4.7925h+0.6050)(−0.4341λ+1.5464) [Equation 12]

(−37.5193h³+46.8087h²−18.7112h+4.1050)(0.0301λ+0.9532)≤b₂(h,λ)≤(−63.9613h³+69.8611h²−24.4022h+4.4343)×(0.0535λ+0.9293) [Equation 13]

(1.5980h−0.1156)(−0.6698λ+2.0303)≤c₂(h,λ)≤(2.3348h−0.2711)×(−0.9655λ+2.2636) [Equation 14]

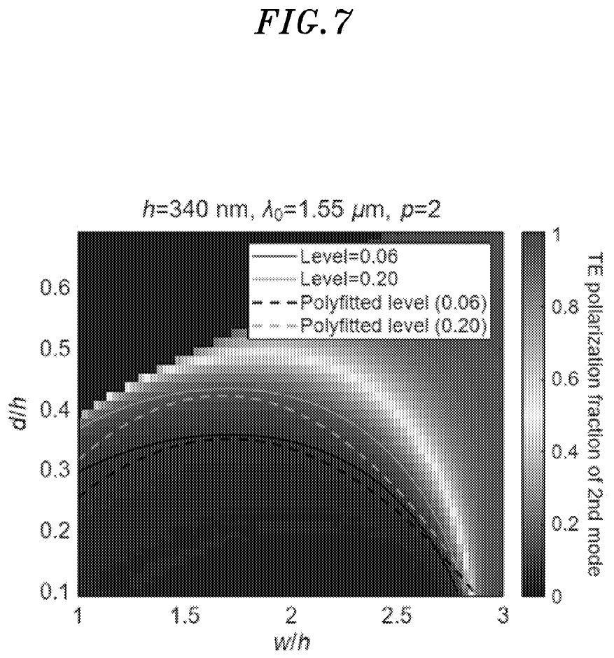

Referring further to FIG. 7, in the coupling region 30, when the longest distance h between the rib 300 and the slab 200 ranges from 250 nm to 500 nm, and the wavelength λ of the light irradiated from the outside ranges from 1.53 μm to 1.57 μm, ai, bi, and ci of Equation 6 may be calculated based on Equation 15 to Equation 20 below. (Here, i is 1 or 2.)

a₁(h,λ)=(4.2804h²−3.6797h+0.5614)(−0.3445λ+1.5113) [Equation 15]

b₁(h,λ)=(35.5586h³−36.9382h²+12.1634h+0.4430)(0.0506λ+0.9230) [Equation 16]

c₁(h,λ)=(1.7963h−0.2547)(−0.8504λ+2.3095) [Equation 17]

a₂(h,λ)=(4.2752h²−3.5308h+0.4708)(−0.2579λ+1.3778) [Equation 18]

b₂(h,λ)=(−37.5193h³+46.8087h²−18.7112h+4.1050)(0.0301λ+0.9532) [Equation 19]

c₂(h,λ)=(1.5980h−0.1156)(−0.6698λ+2.0303) [Equation 20]

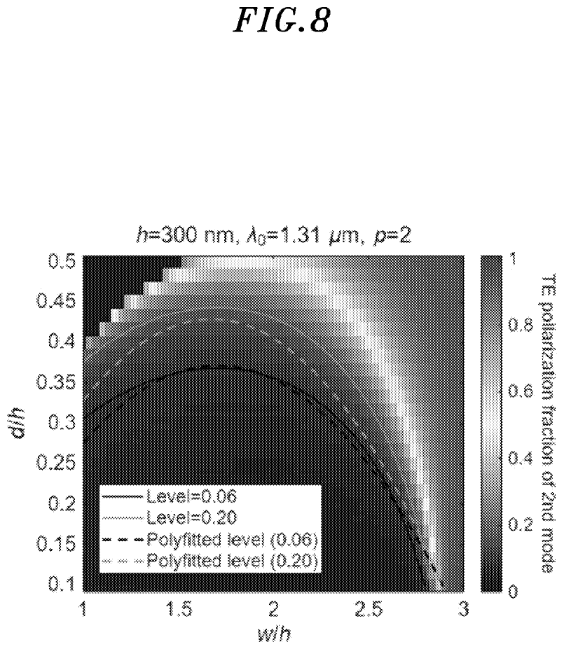

Referring further to FIG. 8, in the coupling region 30, when the longest distance h between the rib 300 and the slab 200 ranges from 200 nm to 400 nm, and the wavelength λ of the light irradiated from the outside ranges from 1.26 μm to 1.36 μm, ai, bi, and ci of Equation 6 may be calculated based on Equation 21 to Equation 26 below. (Here, i is 1 or 2.)

a₁(h,λ)=(7.0208h²−5.1314h+0.7089)×(−0.5667λ+1.7174) [Equation 21]

b₁(h,λ)=(128.7664h³−114.7514h²+33.0248h−1.3520)×(0.0901λ+0.8818) [Equation 22]

c₁(h,λ)=(2.5457h−0.3920)×(−1.1815λ+2.5474) [Equation 23]

a₂=(6.7254h²−4.7925h+0.6050)(−0.4341λ+1.5464) [Equation 24]

b₂(h,λ)=(−63.9613h³+69.8611h²−24.4022h+4.4343)×(0.0535λ+0.9293) [Equation 25]

c₂(h,λ)=(2.3348h−0.2711)×(−0.9655λ+2.2636) [Equation 26]

Hereinafter, actions and effects of the optical waveguide assembly 1 according to the first embodiment of the present disclosure will be described.

Furthermore, optical crosstalk between the optical waveguides 10 and 20 may be substantially eliminated by controlling the electromagnetic field distribution of the coupling region 30 formed between the optical waveguides 10 and 20 in the TM0 mode of the plurality of optical waveguides 10 and 20.

Furthermore, the x-direction coupling coefficient κₓ and the z-direction coupling coefficient κ_{z} among the directional coupling coefficients of the electromagnetic field may be induced to have negative values by manipulating at least one of variables including the thickness d of the slab 200 and the width w of the rib 300. Furthermore, a total coupling coefficient κ may be made to have a value close to 0 by manipulating the above variables. For example, the total coupling coefficient κ may be made to be 0, and when the total coupling coefficient κ becomes 0, optical energy transfer between adjacent optical waveguides may not occur.

Furthermore, since the optical crosstalk may be eliminated without increasing a distance between the optical waveguides 10 and 20, stable signal propagation may be achieved even in an environment with highly integrated optical waveguides. By calculating a cancellation condition of the coupling coefficient κ using the thickness d of the slab 200 and the width w of the rib 300 as variables while maintaining structures of the optical waveguides 10 and 20, existing semiconductor processes may be applied as they are, preventing an increase in complexity of a manufacturing process, and reducing manufacturing costs.

Furthermore, by defining a relation among the thickness d of the slab 200, the width w of the rib 300, and the distance between the optical waveguides 10 and 20, a state where the total coupling coefficient is close to 0 may be maintained even when a process variation or a wavelength change exists, maintaining an optical crosstalk suppression performance even in a broadband wavelength range.

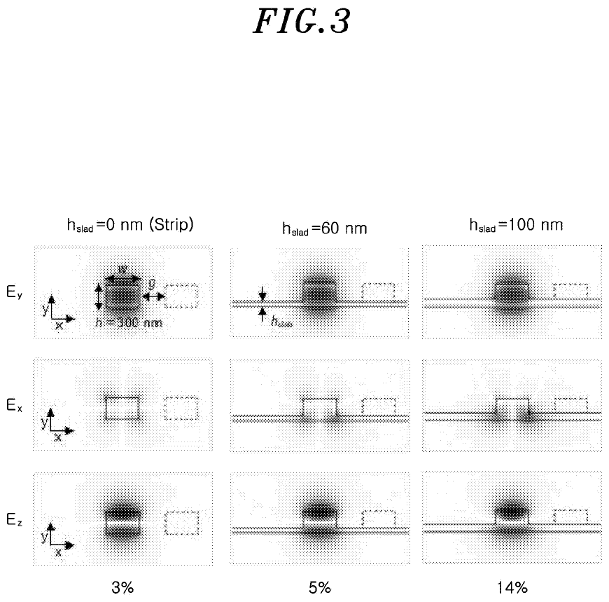

Referring again to FIG. 3, when the optical waveguides 10 and 20 exist independently without being coupled to each other, a distribution of an electric field formed according to the thickness of the slab 200 may be observed. As illustrated in FIG. 3, even when an intensity of the vertical electric field Ey changes when the thickness of the slab 200 changes, a tendency that the vertical electric field Ey is dominantly formed is maintained, and through this, it is seen that the optical waveguides 10 and 20 are placed in the TM0 mode.

As the thickness of the slab 200 increases, an x-direction electric field Ex is shown to gradually increase. In other words, as the thickness of the slab 200 becomes thicker, a ratio of a TE component in the electric field increases, and the TE fraction increases.

Furthermore, in FIG. 3, it is seen that a distribution of a z-direction electric field Ez changes according to the thickness of the slab 200. As the thickness of the slab 200 increases, the distribution of the electric field formed in a lower region of the slab 200 changes in contrast to the distribution of the electric field in an upper region, and it is seen that a phenomenon in which a sign of the electric field changes occurs. In other words, it is seen that a sign change in the distribution of the z-direction electric field Ez occurs as the thickness of the slab 200 increases.

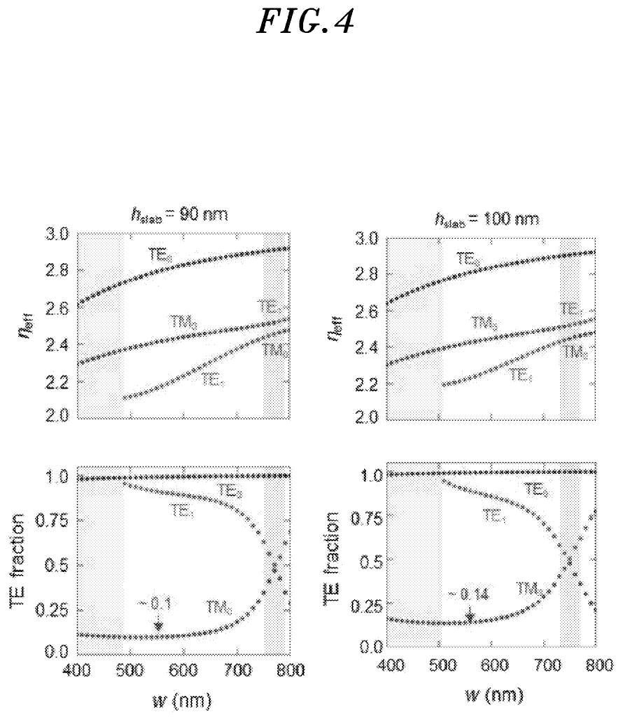

Referring again to FIG. 4, when the optical waveguides 10 and 20 are disposed spaced apart from each other to exist independently without being coupled to each other, it is seen that the TE fraction changes according to the width of the rib 300. As illustrated in FIG. 4, a tendency that a component of the x-direction electric field Ex relatively increases as the width of the rib 300 increases appears, and accordingly, it is seen that the TE fraction increases.

Furthermore, as the width w of the rib 300 increases, it is shown that a section where an effective refractive index of the TM0 mode and an effective refractive index of a TE1 mode approach each other is formed. An interaction or a mode hybridization between the TM0 mode and the TE1 mode may occur by such mode approach. In other words, as the width w of the rib 300 increases, an interaction between modes appears, and it is seen that the TE fraction increases because the ratio of the TE component increases.

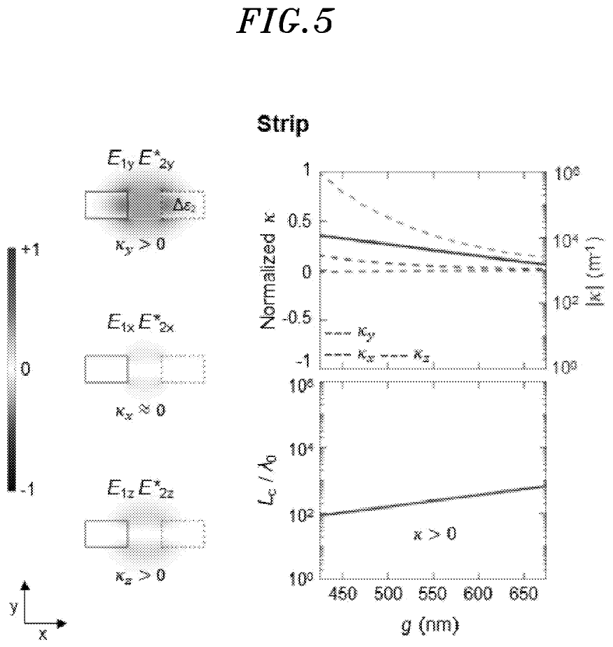

Referring again to FIG. 5, FIG. 5 is a view illustrating a result of calculating a coupling coefficient between the plurality of optical waveguides 10 and 20 as a graph. In other words, FIG. 5 illustrates how respective directional components of coupling coefficients κₓ, κ_{y}, κ_{z} and the total coupling coefficient κ change according to an interval between the plurality of optical waveguides 10 and 20.

Since the y-direction electric field Ey, which is a vertical electric field, is dominantly formed in the TM0 mode, the y-direction coupling coefficient κ_{y} is calculated relatively large correspondingly. Furthermore, since the x-direction electric field Ex is relatively weak in the TM0 mode, it is seen that the x-direction coupling coefficient κₓ converges to 0.

Since the z-direction electric field Ez exists without being completely destroyed in the TM0 mode, it is seen that the z-direction coupling coefficient κ_{z} has a non-zero positive value correspondingly. In other words, it is seen that the x-direction coupling coefficient κₓ converges to 0, and the y-direction coupling coefficient κ_{y} and the z-direction coupling coefficient κ_{z} have positive values in the TM0 mode.

Since the total coupling coefficient κ is defined as a sum of the x-direction coupling coefficient κₓ, the y-direction coupling coefficient κ_{y} and the z-direction coupling coefficient κ_{z} it is seen that the total coupling coefficient κ has a value greater than 0 as long as the y-direction coupling coefficient κ_{y} and the z-direction coupling coefficient κ_{z} are positive numbers even when the x-direction coupling coefficient κₓ converges to 0. It is seen that coupling between the plurality of optical waveguides 10 and 20 is not completely eliminated because coupling by a z-direction electric field component exists even when the y-direction electric field is dominant in the TM0 mode. In other words, it is seen that the total coupling coefficient κ does not converge to 0 in the TM0 mode, and the optical crosstalk between the plurality of optical waveguides 10 and 20 may not be eliminated.

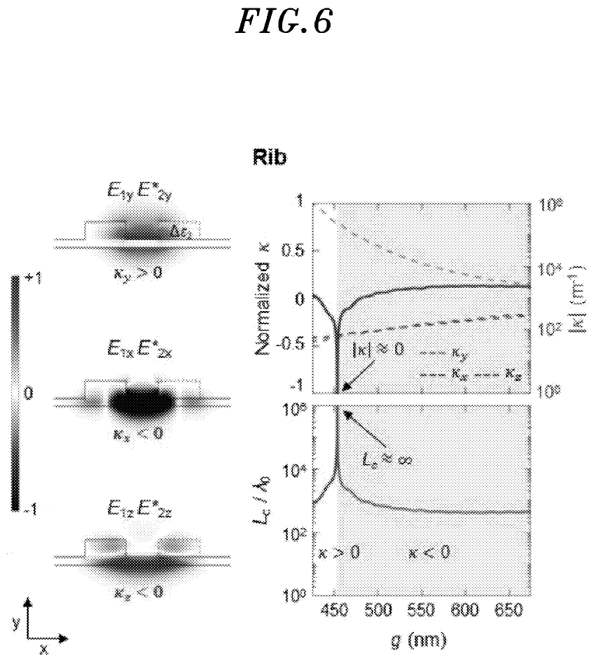

Referring again to FIG. 6, FIG. 6 is a view illustrating a result of calculating the coupling coefficient between the plurality of optical waveguides 10 and 20 as a graph. In other words, FIG. 6 illustrates how the respective directional components of the coupling coefficients κₓ, κ_{y}, κ_{z} and the total coupling coefficient κ change according to the interval between the plurality of optical waveguides 10 and 20.

In the TM0 mode, as the component of the x-direction electric field Ex becomes relatively strong due to a change in the width of the rib 300, the TE fraction increases, and correspondingly, it is seen that the x-direction coupling coefficient κₓ increases.

Furthermore, as an electric field distribution changes, it is seen that a section is formed where the y-direction coupling coefficient κ_{y} maintains a positive value, and the x-direction coupling coefficient κₓ and the z-direction coupling coefficient κ_{z} have negative values. In other words, it is seen that respective directional coupling coefficients κₓ, κ_{y}, κ_{z} are formed to have different signs in the coupling region 30.

Since the total coupling coefficient κ is defined as the sum of the x-direction coupling coefficient κₓ, the y-direction coupling coefficient κ_{y}, and the z-direction coupling coefficient κ_{z}, it is seen that a point where the total coupling coefficient κ converges to 0 is formed as the y-direction coupling coefficient κ_{y} having a positive value and the x-direction coupling coefficient κₓ and the z-direction coupling coefficient κ_{z} having negative values cancel each other out.

By changing the electric field distribution, signs of the respective directional components of the coupling coefficients κₓ, κ_{y}, κ_{z} may be adjusted, and a condition where the total coupling coefficient K becomes 0 may be formed. In other words, coupling between the plurality of optical waveguides 10 and 20 in the coupling region 30 is suppressed, and thereby the optical crosstalk may be eliminated.

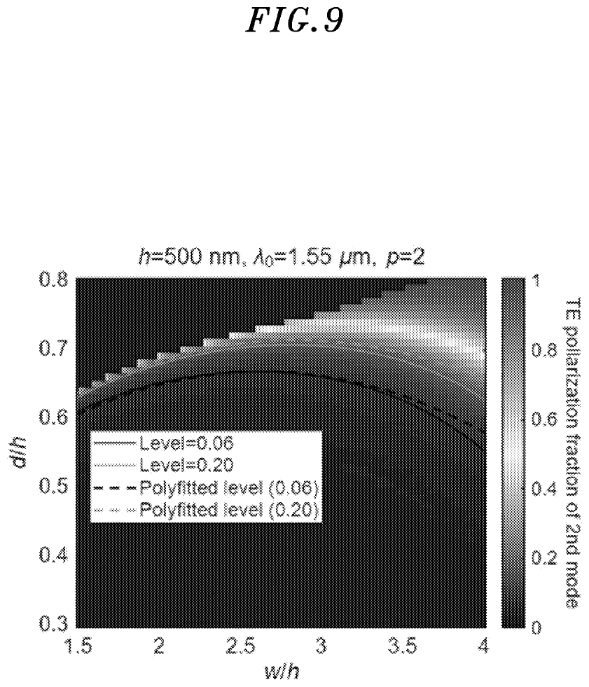

Meanwhile, in addition to such a configuration, an optical waveguide assembly 1 according to a second embodiment of the present disclosure may be provided. Hereinafter, the second embodiment of the present disclosure will be described with reference to FIGS. 9 to 11. In describing the second embodiment, differences from the above-described embodiment will be mainly described, and the same description refers to the above-described embodiment.

The slab 200 and the rib 300 may include at least one of Li, Nb, and O. For example, the lower cladding 100, the slab 200, and the rib 300 may include TFLN (thin-film lithium niobate, LiNbO3), but are not limited thereto.

In the coupling region 30, when the longest distance h between the rib 300 and the slab 200 ranges from 200 nm to 400 nm, and the wavelength λ of the light irradiated from the outside ranges from 1.26 μm to 1.36 μm, ai, bi, and ci of Equation 6 may be calculated based on Equation 27 to Equation 32 below. (Here, i is 1 or 2.)

(4.0903h²−1.5939h+0.0934)×(0.0310λ+0.9725)≤a₁(h,λ)≤(2.9703h²−2.3222h+0.3705)×(−0.4970λ+1.7703) [Equation 27]

(0h³+144.7256h²−56.2606h+7.8288)×(−0.4214λ+1.3297)≤b₁(h,λ)≤(0h³+23.9640h²−20.0347h+6.666)×(−0.1845λ+1.2861) [Equation 28]

(3.0411h−0.0604)×(−1.6718λ+2.3044)≤c₁(h,λ)≤(1.3111h+0.0125)×(−0.7034λ+2.0905) [Equation 29]

(6.1017h²−2.3528h+0.1599)×(0.6877λ+0.4574)≤a₂≤(3.7048h²−2.8283h+0.4455)×(−0.2401λ+1.3694) [Equation 30]

(0h³+143.3224h²−56.2086h+8.0672)×(−0.4138λ+1.3242)≤b₂(h,λ)≤(0h³+26.4708h²−22.3673h+7.4035)×(−0.0798λ+1.1237) [Equation 31]

(3.0010h−0.0060)×(−1.4116λ+2.1009)≤c₂(h,λ)≤(1.2941h+0.0668)×(−0.6424λ+1.9957) [Equation 32]

Referring again to FIG. 9, in the coupling region 30, when the longest distance h between the rib 300 and the slab 200 ranges from 300 nm to 500 nm, and the wavelength λ of the light irradiated from the outside ranges from 1.53 μm to 1.57 μm, ai, bi, and ci of Equation 6 may be calculated based on Equation 33 to Equation 38 below. (Here, i is 1 or 2.)

a₁(h,λ)=(2.9703h²−2.3222h+0.3705)×(−0.4970λ+1.7703) [Equation 33]

b₁(h,λ)=(0h³+23.9640h²−20.0347h+6.666)×(−0.1845λ+1.2861) [Equation 34]

c₁(h,λ)=(1.3111h+0.0125)×(−0.7034λ+2.0905) [Equation 35]

a₂=(3.7048h²−2.8283h+0.4455)×(−0.2401λ+1.3694) [Equation 36]

b₂(h,λ)=(0h³+26.4708h²−22.3673h+7.4035)×(−0.0798λ+1.1237) [Equation 37]

c₂(h,λ)=(1.2941h+0.0668)×(−0.6424λ+1.9957) [Equation 38]

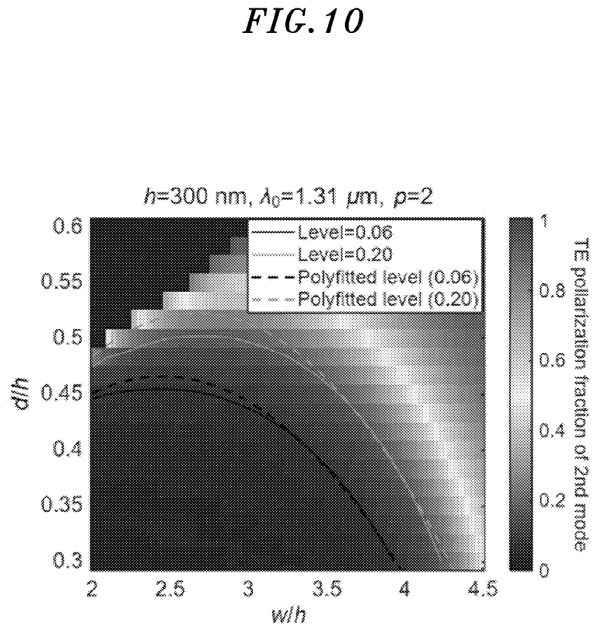

Referring again to FIG. 10, in the coupling region 30, when the longest distance h between the rib 300 and the slab 200 ranges from 300 nm to 400 nm, and the wavelength λ of the light irradiated from the outside ranges from 1.26 μm to 1.36 μm, ai, bi, and ci of Equation 6 may be calculated based on Equation 39 to Equation 44 below. (Here, i is 1 or 2.)

a₁(h,λ)=(7.7562h²−5.3140h+0.8223)×(−0.5333λ+1.6978) [Equation 39]

b₁(h,λ)=(0h³−4.7840h²+3.5586h+1.8041)×(−0.2813λ+1.3706) [Equation 40]

c₁(h,λ)=(1.7453h−0.0584)×(−0.9183λ+2.2043) [Equation 41]

a₂(h,λ)=(9.1378h²−6.1766h+0.9451)×(−0.3027λ+1.3938) [Equation 42]

b₂(h,λ)=(0h³−5.9328h²+3.6708h+2.0987)×(−0.2055λ+1.2709) [Equation 43]

c₂(h,λ)=(1.6740h+0.0197)×(−0.8012λ+2.0505) [Equation 44]

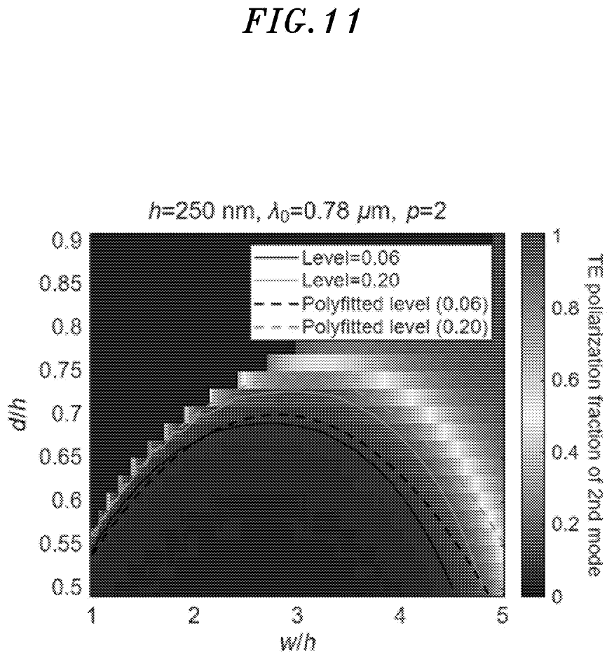

Referring again to FIG. 11, in the coupling region 30, when the longest distance h between the rib 300 and the slab 200 ranges from 150 nm to 250 nm, and the wavelength λ of the light irradiated from the outside ranges from 0.765 μm to 0.795 μm, ai, bi, and ci of Equation 6 may be calculated based on Equation 45 to Equation 50 below. (Here, i is 1 or 2.)

a₁(h,λ)=(4.0903h²−1.5939h+0.0934)×(0.0310λ+0.9725) [Equation 45]

b₁(h,λ)=(0h³+144.7256h²−56.2606h+7.8288)×(−0.4214λ+1.3297) [Equation 46]

c₁(h,λ)=(3.0411h−0.0604)×(−1.6718λ+2.3044) [Equation 47]

a₂(h,λ)=(6.1017h²−2.3528h+0.1599)×(0.6877λ+0.4574) [Equation 48]

b₂(h,λ)=(0h³+143.3224h²−56.2086h+8.0672)×(−0.4138λ+1.3242) [Equation 49]

c₂(h,λ)=(3.0010h−0.0060)×(−1.4116λ+2.1009) [Equation 50]

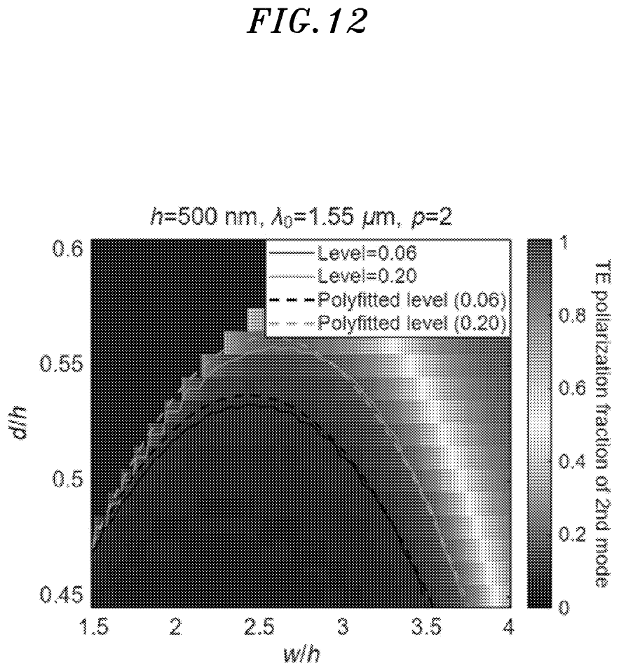

Meanwhile, in addition to such a configuration, an optical waveguide assembly 1 according to a third embodiment of the present disclosure may be provided. Hereinafter, the third embodiment of the present disclosure will be described with reference to FIGS. 12 to 14. In describing the third embodiment, differences from the above-described embodiment will be mainly described, and the same description refers to the above-described embodiment.

The slab 200 and the rib 300 may include Si and N. For example, the lower cladding 100, the slab 200, and the rib 300 may include silicon nitride (Si3N4), but are not limited thereto.

In the coupling region 30, when the longest distance h between the rib 300 and the slab 200 ranges from 200 nm to 600 nm, and the wavelength λ of the light irradiated from the outside ranges from 0.76 μm to 1.57 μm, the ai, bi, and ci of Equation 6 may be calculated based on Equation 51 to Equation 56 below. (Here, i is 1 or 2.)

(0.9402h²−0.7537h+0.0459)×(−1.8027λ+2.4099)≤a₁(h,λ)≤(0.4882h²−0.6022h+0.1045)×(−0.7325λ+2.1352) [Equation 51]

(0h³+43.7154h²−26.5812h+6.3494)×(0.6160λ+0.5205)≤b₁(h,λ)≤(−54.3454h³+93.7517h²−55.2117h+13.3936)×(0.4589λ+0.2888) [Equation 52]

(1.1096h+0.2540)×(−0.6370λ+1.4969)≤c₁(h,λ)≤(0.5449h+0.2648)×(−0.3130λ+1.4852) [Equation 53]

(1.8940h²−1.2744h+0.1025)×(−2.3004λ+2.8001)≤a₂≤(0.7324h²−0.8781h+0.1751)×(−0.8580λ+2.3306) [Equation 54]

(0h³+40.1460h²−25.0287h+6.3345)×(0.5239λ+0.5927)≤b₂(h,λ)≤(−71.7281h³+121.2376h²−69.7364h+16.0803)×(0.5047λ+0.2177) [Equation 55]

(1.1140h+0.2798)×(−0.6273λ+1.4892)≤c₂(h,λ)≤(0.5688h+0.2779)×(−0.3019λ+1.4680) [Equation 56]

Referring again to FIG. 12, in the coupling region 30, when the longest distance h between the rib 300 and the slab 200 ranges from 350 nm to 600 nm, and the wavelength λ of the light irradiated from the outside ranges from 1.53 μm to 1.57 μm, ai, bi, and ci of Equation 6 may be calculated based on Equation 57 to Equation 62 below. (Here, i is 1 or 2.)

a₁(h,λ)=(0.4882h²−0.6022h+0.1045)×(−0.7325λ+2.1352) [Equation 57]

b₁(h,λ)=(−54.3454h³+93.7517h²−55.2117h+13.3936)×(0.4589λ+0.2888) [Equation 58]

c₁(h,λ)=(0.5449h+0.2648)×(−0.3130λ+1.4852) [Equation 59]

a₂=(0.7324h²−0.8781h+0.1751)×(−0.8580λ+2.3306) [Equation 60]

b₂(h,λ)=(−71.7281h³+121.2376h²−69.7364h+16.0803)×(0.5047λ+0.2177) [Equation 61]

c₂(h,λ)=(0.5688h+0.2779)×(−0.3019λ+1.4680) [Equation 62]

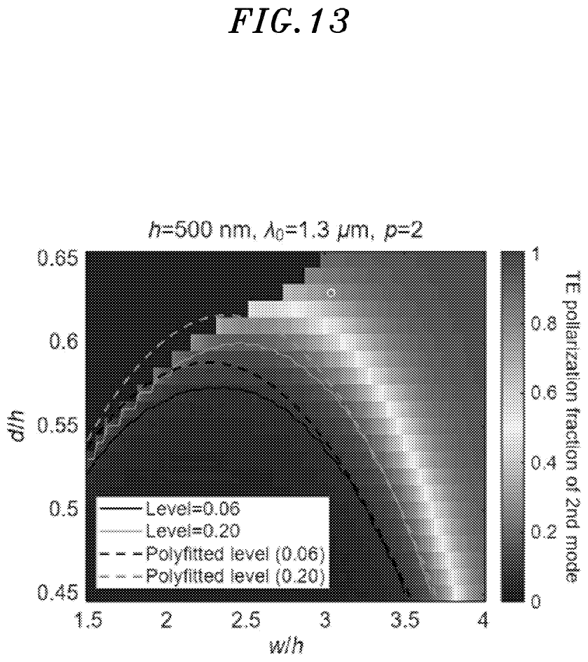

Referring again to FIG. 13, in the coupling region 30, when the longest distance h between the rib 300 and the slab 200 ranges from 300 nm to 500 nm, and the wavelength λ of the light irradiated from the outside ranges from 1.26 μm to 1.36 μm, ai, bi, and ci of Equation 6 may be calculated based on Equation 63 to Equation 68 below. (Here, i is 1 or 2.)

a₁(h,λ)=(0.5362h²−0.6056h+0.0826)×(−0.9016λ+2.1835) [Equation 63]

b₁(h,λ)=(−96.4897h³+136.1767h²−66.0737h+13.3296)×(0.4994λ+0.3464) [Equation 64]

c₁(h,λ)=(0.6397h+0.2660)×(−0.3627λ+1.4754) [Equation 65]

a₂=(1.0648h²−1.0616h+0.1691)×(−1.0307λ+2.3510) [Equation 66]

b₂(h,2)=(−103.5869h³+142.8166h²−68.0991h+13.6835)×(0.4890λ+0.3601) [Equation 67]

c₂(h,2)=(0.6654h+0.2812)×(−0.3644λ+1.4776) [Equation 68]

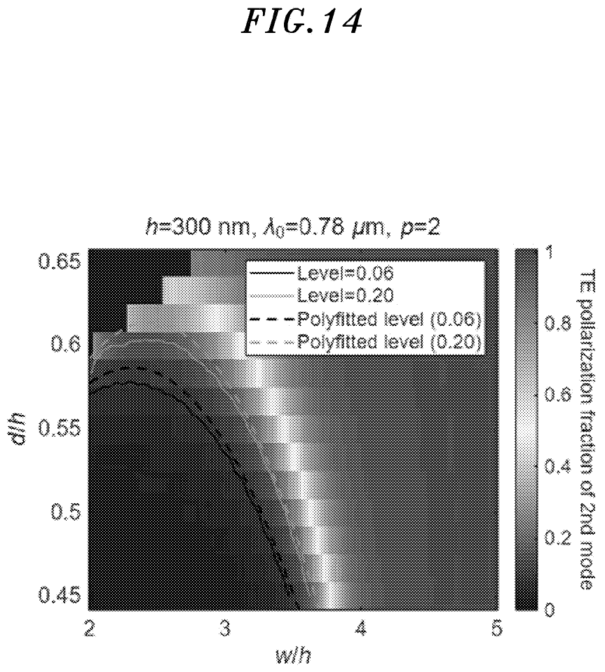

Referring again to FIG. 14, in the coupling region 30, when the longest distance h between the rib 300 and the slab 200 ranges from 200 nm to 300 nm, and the wavelength λ of the light irradiated from the outside ranges from 0.76 μm to 0.8 μm, ai, bi, and ci of Equation 6 may be calculated based on Equation 69 to Equation 74 below. (Here, i is 1 or 2.)

a₁(h,λ)=(0.9402h²−0.7537h+0.0459)×(−1.8027λ+2.4099) [Equation 69]

b₁(h,λ)=(0h³+43.7154h²−26.5812h+6.3494)×(0.6160λ+0.5205) [Equation 70]

c₁(h,λ)=(1.1096h+0.2540)×(−0.6370λ+1.4969) [Equation 71]

a₂(h,λ)=(1.8940h²−1.2744h+0.1025)×(−2.3004λ+2.8001) [Equation 72]

b₂(h,λ)=(0h³+40.1460h²−25.0287h+6.3345)×(0.5239λ+0.5927) [Equation 73]

c₂(h,λ)=(1.1140h+0.2798)×(−0.6273λ+1.4892) [Equation 74]

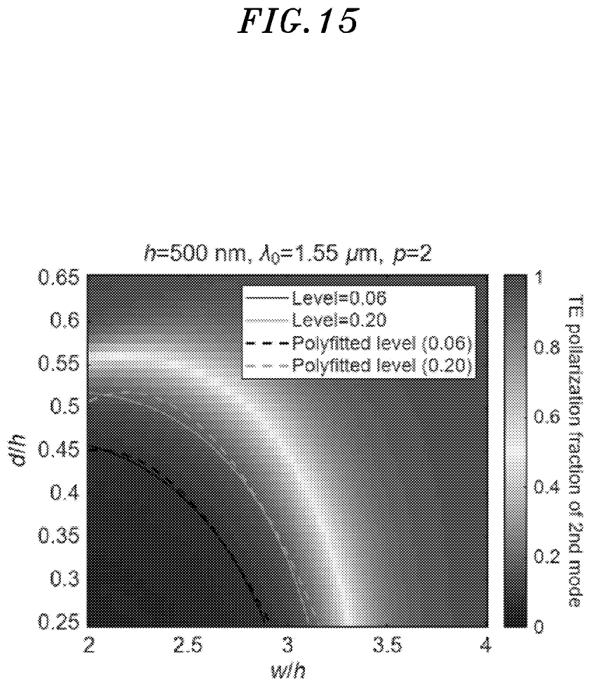

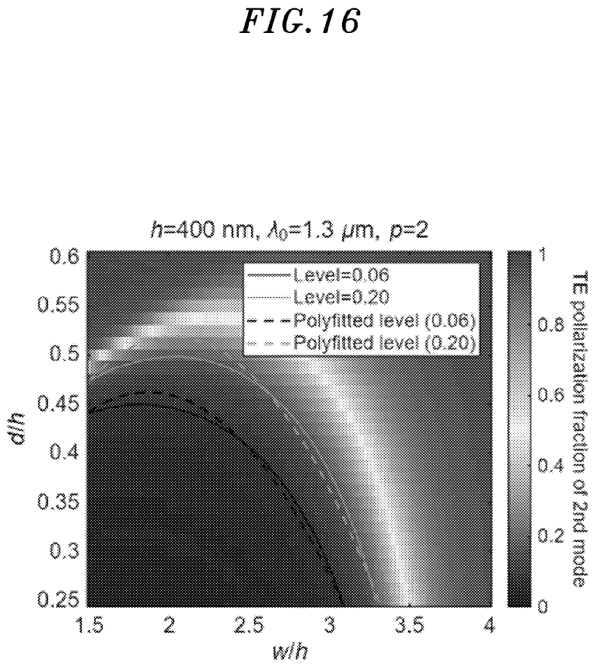

Meanwhile, in addition to such a configuration, an optical waveguide assembly 1 according to a fourth embodiment of the present disclosure may be provided. Hereinafter, the fourth embodiment of the present disclosure will be described with reference to FIGS. 15 and 16. In describing the fourth embodiment, differences from the above-described embodiment will be mainly described, and the same description refers to the above-described embodiment.

The slab 200 and the rib 300 may include at least one of Li, Ta or O. For example, the lower cladding 100, the slab 200, and the rib 300 may include TFLT (thin-film lithium tantalate, LiTIO3), but are not limited thereto.

In the coupling region 30, when the longest distance h between the rib 300 and the slab 200 ranges from 300 nm to 500 nm, and the wavelength λ of the light irradiated from the outside ranges from 1.26 μm to 1.57 μm, ai, bi, and ci of Equation 6 may be calculated based on Equation 75 to Equation 80 below. (Here, i is 1 or 2.)

(−0.5282h²−0.4074h+0.0750)×(−1.6357λ+3.5388)≤a₁(h,λ)≤(7.2287h²−5.5571h+0.9227)×(−1.8058λ+3.3663) [Equation 75]

(6.9131h³+14.9322h²−18.9589h+6.9147)×(0.3166λ+0.5093)≤b₁(h,λ)≤(0h³−11.5154h²+4.2365h+2.0228)×(0.3142λ+0.5885) [Equation 76]

(0.4820h+0.2100)×(−0.2732λ+1.4235)≤c₁(h,λ)≤(0.7150h+0.1745)×(−0.3925λ+1.5146) [Equation 77]

(−0.0867h²−0.8051h+0.1380)×(−1.6950λ+3.6309)≤a₂≤(9.3541h²−7.0438h+1.1602)×(−1.7683λ+3.3174) [Equation 78]

(18.3740h³+1.5265h²−14.1741h+6.5985)×(0.2961λ+0.5413)≤b₂(h,λ)≤(0h³−9.5687h²+2.3057h+2.6414)×(0.3406λ+0.5538) [Equation 79]

(0.6238h+0.2060)×(−0.3070λ+1.4756)≤c₂(h,λ)≤(0.8353h+0.1823)×(−0.4180λ+1.5481) [Equation 80]

Referring again to FIG. 15, in the coupling region 30, when the longest distance h between the rib 300 and the slab 200 ranges from 300 nm to 500 nm, and the wavelength λ of the light irradiated from the outside ranges from 1.53 μm to 1.57 μm, ai, bi, and ci of Equation 6 may be calculated based on Equation 81 to Equation 86 below. (Here, i is 1 or 2.)

a₁(h,λ)=(−0.5282h²−0.4074h+0.0750)×(−1.6357λ+3.5388) [Equation 81]

b₁(h,λ)=(6.9131h³+14.9322h²−18.9589h+6.9147)×(0.3166λ+0.5093) [Equation 82]

c₁(h,λ)=(0.4820h+0.2100)×(−0.2732λ+1.4235) [Equation 83]

a₂(h,λ)=(−0.0867h²−0.8051h+0.1380)×(−1.6950λ+3.6309) [Equation 84]

b₂(h,λ)=(18.3740h³+1.5265h²−14.1741h+6.5985)×(0.2961λ+0.5413) [Equation 85]

c₂(h,λ)=(0.6238h+0.2060)×(−0.3070λ+1.4756) [Equation 86]

Referring again to FIG. 16, in the coupling region 30, when the longest distance h between the rib 300 and the slab 200 ranges from 300 nm to 400 nm, and the wavelength λ of the light irradiated from the outside ranges from 1.26 μm to 1.36 μm, ai, bi, and ci of Equation 6 may be calculated based on Equation 87 to Equation 92 below. (Here, i is 1 or 2.)

a₁(h,λ)=(7.2287h²−5.5571h+0.9227)×(−1.8058λ+3.3663) [Equation 87]

b₁(h,λ)=(0h³−11.5154h²+4.2365h+2.0228)×(0.3142λ+0.5885) [Equation 88]

c₁(h,λ)=(0.7150h+0.1745)×(−0.3925λ+1.5146) [Equation 89]

a₂=(9.3541h²−7.0438h+1.1602)×(−1.7683λ+3.3174) [Equation 90]

b₂(h,λ)=(0h³−9.5687h²+2.3057h+2.6414)×(0.3406λ+0.5538) [Equation 91]

c₂(h,λ)=(0.8353h+0.1823)×(−0.4180λ+1.5481) [Equation 92]

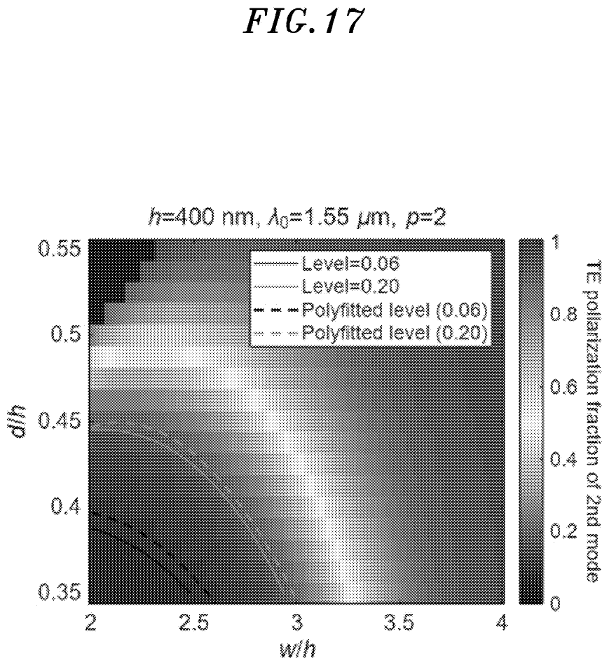

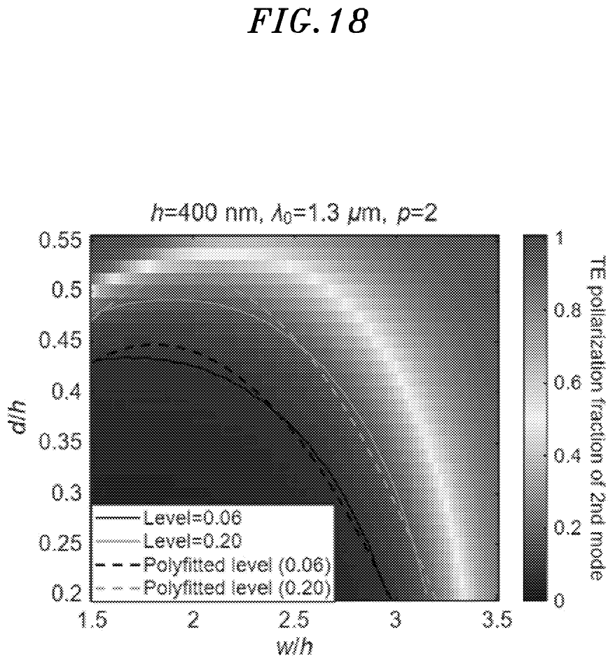

Meanwhile, in addition to such a configuration, an optical waveguide assembly 1 according to a fifth embodiment of the present disclosure may be provided. Hereinafter, the fifth embodiment of the present disclosure will be described with reference to FIGS. 17 and 18. In describing the fifth embodiment, differences from the above-described embodiment will be mainly described, and the same description refers to the above-described embodiment.

The slab 200 and the rib 300 may include at least one of Ba, Ti, and O. For example, the lower cladding 100, the slab 200, and the rib 300 may include barium titanate (BatiO3), but are not limited thereto.

In the coupling region 30, when the longest distance h between the rib 300 and the slab 200 ranges from 200 nm to 500 nm, and the wavelength of the light irradiated from the outside ranges from 1.26 μm to 1.57 μm, ai, bi, and ci of Equation 6 may be calculated based on Equation 93 to Equation 98 below. (Here, i is 1 or 2.)

(−0.5113h²−0.0697h+0.0026)×(−2.0302λ+4.1441)≤a₁(h,λ)≤(12.2501h²−9.1733h+1.5302)×(−1.8778λ+3.4656) [Equation 93]

(0h³−20.2498h²−18.8865h+6.2122)×(0.1569λ+0.7563)≤b₁(h,λ)≤(0h³−23.5823h²+13.5943h+0.1429)×(0.1419λ+0.8156) [Equation 94]

(0.6112h+0.1533)×(−0.3951λ+1.6125)≤c₁(h,λ)≤(0.8689h+0.0973)×(−0.4900λ+1.6421) [Equation 95]

(0.2377h²−0.7678h+0.1315)×(−1.4150λ+3.1953)≤a₂≤(15.8959h²−11.6936h+1.9322)×(−1.7315λ+3.2714) [Equation 96]

(0h³+18.4494h²−17.7013h+6.2640)×(0.3303λ+0.4886)≤b₂(h,λ)≤(0h³−21.7569h²+11.7518h+0.7363)×(0.2032λ+0.7351) [Equation 97]

(0.7126h+0.1641)×(−0.4156λ+1.6441)≤c₂(h,λ)≤(0.9799h+0.1199)×(−0.4912λ+1.6435) [Equation 98]

Referring again to FIG. 17, in the coupling region 30, when the longest distance h between the rib 300 and the slab 200 ranges from 300 nm to 500 nm, and the wavelength λ of the light irradiated from the outside ranges from 1.53 μm to 1.57 μm, ai, bi, and ci of Equation 6 may be calculated based on Equation 99 to Equation 104 below. (Here, i is 1 or 2.)

a₁(h,λ)=(−0.5113h²−0.0697h+0.0026)×(−2.0302λ+4.1441) [Equation 99]

b₁(h,λ)=(0h³−20.2498h²−18.8865h+6.2122)×(0.1569λ+0.7563) [Equation 100]

c₁(h,λ)=(0.6112h+0.1533)×(−0.3951λ+1.6125) [Equation 101]

a₂(h,λ)=(0.2377h²−0.7678h+0.1315)×(−1.4150λ+3.1953) [Equation 102]

b₂(h,λ)=(0h³+18.4494h²−17.7013h+6.2640)×(0.3303λ+0.4886) [Equation 103]

c₂(h,λ)=(0.7126h+0.1641)×(−0.4156λ+1.6441) [Equation 104]

Referring again to FIG. 18, in the coupling region 30, when the longest distance h between the rib 300 and the slab 200 ranges from 300 nm to 400 nm or less, and the wavelength λ of the light irradiated from the outside ranges from 1.26 μm to 1.36 μm or less, ai, bi, and ci of Equation 6 may be calculated based on Equation 105 to Equation 110 below. (Here, i is 1 or 2.)

a₁(h,λ)=(12.2501h²−9.1733h+1.5302)×(−1.8778λ+3.4656) [Equation 105]

b₁(h,λ)=(0h³−23.5823h²+13.5943h+0.1429)×(0.1419λ+0.8156) [Equation 106]

c₁(h,λ)=(0.8689h+0.0973)×(−0.4900λ+1.6421) [Equation 107]

a₂=(15.8959h²−11.6936h+1.9322)×(−1.7315λ+3.2714) [Equation 108]

b₂(h,λ)=(0h³−21.7569h²+11.7518h+0.7363)×(0.2032λ+0.7351) [Equation 109]

c₂(h,λ)=(0.9799h+0.1199)×(−0.4912λ+1.6435) [Equation 110]

Although the embodiments of the present disclosure have been described as specific embodiments above, these are merely examples, and the present disclosure is not limited thereto, and should be construed as having a broadest scope according to the technical idea disclosed in the present specification. Those skilled in the art may implement a pattern of a shape not specified by combining/substituting the disclosed embodiments, but this also does not depart from the scope of the present disclosure. In addition, those skilled in the art may easily change or modify the disclosed embodiments based on the present specification, and it is obvious that such changes or modifications also fall within the right scope of the present disclosure.

What is claimed is:

1. A rib waveguide with eliminated optical crosstalk, comprising:
a plurality of optical waveguides spaced apart from each other and configured to allow light to pass therethrough; and
a coupling region including a space between each waveguide and an adjacent waveguide to the each waveguide,
wherein, when the light passes through the plurality of optical waveguides, electric fields formed by the plurality of optical waveguides overlap in the coupling region,
wherein, in the coupling region,
an electric field component in a propagation direction of the light is greater than that of a magnitude of a magnetic field component in the propagation direction, and
the overlapped electric fields are formed such that magnitude of an electric field component in a horizontal direction which is a spacing direction between adjacent optical waveguides, is smaller than magnitude of electric field components in the propagation direction and in a vertical direction perpendicular to the propagation direction and the horizontal direction.

2. The rib waveguide with eliminated optical crosstalk of claim 1, wherein a TE fraction defined as the electric field component in the horizontal direction and the electric field component in the vertical direction where no overlap of electric fields occurs for each of the plurality of optical waveguides, ranges from 6% to 20%.

3. The rib waveguide with eliminated optical crosstalk of claim 2, wherein the TE fraction of the coupling region is calculated based on the following Equation 1:
$$\frac{\int {\vert Ex \vert}^{2} d x d y}{\int ( {\vert Ex \vert}^{2} + {\vert Ey \vert}^{2} ) d x d y} \times 100 \qquad [ Equation 1 ]$$
where Ex is a magnitude of the horizontal electric field, and Ey is a magnitude of the vertical electric field.

4. The rib waveguide with eliminated optical crosstalk of claim 1, wherein a coupling coefficient κₓ in the horizontal direction in the coupling region and a coupling coefficient κ_{z} in the propagation direction in the coupling region are defined by the following Equation 2 and Equation 3, respectively, and the coupling coefficient κₓ and the coupling coefficient κ_{z} each have a negative value:
$${κ}_{x} = \frac{ω {ε}_{0}}{4} \int \int Δ {ε}_{x} ( x , y ) {E}_{1 x} ( x , y ) {E}_{2 x}^{*} ( x , y ) dxdy \qquad [ Equation 2 ]$$
$${κ}_{z} = \frac{ω {ε}_{0}}{4} \int \int Δ {ε}_{z} ( x , y ) {E}_{1 z} ( x , y ) {E}_{2 z}^{*} ( x , y ) d x d y \qquad [ Equation 3 ]$$
where ω is an angular frequency, ε₀ is a free-space permittivity, Δεₓ is a variation in horizontal permittivity, Δε_{z} is a variation in propagation-direction permittivity, E₁ₓ(x,y) is a horizontal electric field in a first optical waveguide of the plurality of optical waveguides,
$${E}_{2 x}^{*} ( x , y )$$
is a horizontal electric field in a second optical waveguide of the plurality of optical waveguides, E_{1z}(x,y) is a propagation-direction electric field in the first optical waveguide, and
$${E}_{2 z}^{*} ( x , y )$$
is a propagation-direction electric field in the second optical waveguide.

5. The rib waveguide with eliminated optical crosstalk of claim 4, wherein a coupling coefficient κ_{y} in the vertical direction in the coupling region is calculated based on the following Equation 4:
$${κ}_{y} = \frac{ω {ε}_{0}}{4} \int \int Δ {ε}_{y} ( x , y ) {E}_{1 y} ( x , y ) {E}_{2 y}^{*} ( x , y ) d x d y \qquad [ Equation 4 ]$$
where ω is an angular frequency, ε₀ is a free-space permittivity, Δε_{y} is a variation in vertical permittivity, E_{1y}(x,y) is a vertical electric field in the first optical waveguide, and
$${E}_{2 y}^{*} ( x , y )$$
is a vertical electric field in the second optical waveguide.

6. The rib waveguide with eliminated optical crosstalk of claim 5, wherein a coupling coefficient κ is defined by the following Equation 5, and the coupling coefficient κ is equal to zero,
κ=κₓ+κ_{y}+κ_{z} [Equation 5]

7. The rib waveguide with eliminated optical crosstalk of claim 1, wherein the plurality of optical waveguides comprise:
a slab; and
a rib disposed on the slab,
wherein the plurality of optical waveguides are configured such that light incident from an outside passes through the slab and the rib.

8. The rib waveguide with eliminated optical crosstalk of claim 7, wherein the slab and the rib comprise different compositions.

9. The rib waveguide with eliminated optical crosstalk of claim 7, wherein a thickness of the slab and a width of the rib in the coupling region are defined by the following Equation 6 to Equation 8:
$${{a}_{1} ( x - {b}_{1} )}^{2} + {c}_{1} < y < {{a}_{2} ( x - {b}_{2} )}^{2} + {c}_{2} \qquad [ Equation 6 ]$$
$$x = \frac{w}{h} \qquad [ Equation 7 ]$$
$$y = \frac{d}{h} \qquad [ Equation 8 ]$$
where w denotes the width of the rib, d denotes the thickness of the slab, h denotes a longest distance between the rib and the slab, a1, b1, and c1 are constants derived from a lower limit value in a corresponding graph of the x and the y in the coupling region, and a2, b2, and c2 are constants calculated derived from an upper limit value in the corresponding graph of the x and the y in the coupling region.

10. The rib waveguide with eliminated optical crosstalk of claim 9, wherein, when the plurality of optical waveguides comprise Si and do not comprise N, h ranges from 200 nm to 500 nm, and a wavelength λ ranges from 1.26 μm to 1.57 μm, the ai, bi, and ci are defined by the following Equation 9 to Equation 14, where i is 1 or 2:
(4.2804h²−3.6797h+0.5614)(−0.3445λ+1.5113)≤a₁(h,λ)≤(7.0208h²−5.1314h+0.7089)×(−0.5667λ+1.7174) [Equation 9]
(35.5586h³−36.9382h²+12.1634h+0.4430)(0.0506λ+0.9230)≤b₁(h,λ)≤(128.7664h³−114.7514h²+33.0248h−1.3520)×(0.0901λ+0.8818) [Equation 10]
(1.7963h−0.2547)(−0.8504λ+2.3095)≤c₁(h,λ)≤(2.5457h−0.3920)×(−1.1815λ+2.5474) [Equation 11]
(4.2752h²−3.5308h+0.4708)(−0.2579λ+1.3778)≤a₂≤(6.7254h²−4.7925h+0.6050)(−0.4341λ+1.5464) [Equation 12]
(−37.5193h³+46.8087h²−18.7112h+4.1050)(0.0301λ+0.9532)≤b₂(h,λ)≤(−63.9613h³+69.8611h²−24.4022h+4.4343)×(0.0535λ+0.9293) [Equation 13]
(1.5980h−0.1156)(−0.6698λ+2.0303)≤c₂(h,λ)≤(2.3348h−0.2711)×(−0.9655λ+2.2636) [Equation 14]

11. The rib waveguide with eliminated optical crosstalk of claim 10, wherein, when the plurality of optical waveguides comprise Si and do not comprise N, h ranges from 250 nm to 500 nm, and a wavelength λ ranges from 1.53 μm to 1.57 μm, the ai, bi, and ci are defined by the following Equation 15 to Equation 20, where i is 1 or 2:
a₁(h,λ)=(4.2804h²−3.6797h+0.5614)(−0.3445λ+1.5113) [Equation 15]
b₁(h,λ)=(35.5586h³−36.9382h²+12.1634h+0.4430)(0.0506λ+0.9230) [Equation 16]
c₁(h,λ)=(1.7963h−0.2547)(−0.8504λ+2.3095) [Equation 17]
a₂(h,λ)=(4.2752h²−3.5308h+0.4708)(−0.2579λ+1.3778) [Equation 18]
b₂(h,λ)=(−37.5193h³+46.8087h²−18.7112h+4.1050)(0.0301λ+0.9532) [Equation 19]
c₂(h,λ)=(1.5980h−0.1156)(−0.6698λ+2.0303) [Equation 20]

12. The rib waveguide with eliminated optical crosstalk of claim 10, wherein, when the plurality of optical waveguides comprise Si and do not comprise N, h ranges from 200 nm to 400 nm, and a range of a wavelength λ ranges from 1.26 μm to 1.36 μm, the ai, bi, and ci are defined by the following Equation 21 to Equation 26, where i is 1 or 2:
a₁(h,λ)=(7.0208h²−5.1314h+0.7089)×(−0.5667λ+1.7174) [Equation 21]
b₁(h,λ)=(128.7664h³−114.7514h²+33.0248h−1.3520)×(0.0901λ+0.8818) [Equation 22]
c₁(h,λ)=(2.5457h−0.3920)×(−1.1815λ+2.5474) [Equation 23]
a₂=(6.7254h²−4.7925h+0.6050)(−0.4341λ+1.5464) [Equation 24]
b₂(h,λ)=(−63.9613h³+69.8611h²−24.4022h+4.4343)×(0.0535λ+0.9293) [Equation 25]
c₂(h,λ)=(2.3348h−0.2711)×(−0.9655λ+2.2636) [Equation 26]

13. The rib waveguide with eliminated optical crosstalk of claim 8, wherein, when the plurality of optical waveguides comprise at least one of Li, Nb, or O, h ranges from 150 nm to 500 nm, and a wavelength λ ranges from 0.765 μm to 1.57 μm, the ai, bi, and ci are defined by the following Equation 27 to Equation 32, where i is 1 or 2:
(4.0903h²−1.5939h+0.0934)×(0.0310λ+0.9725)≤a₁(h,λ)≤(2.9703h²−2.3222h+0.3705)×(−0.4970λ+1.7703) [Equation 27]
(0h³+144.7256h²−56.2606h+7.8288)×(−0.4214λ+1.3297)≤b₁(h,λ)≤(0h³+23.9640h²−20.0347h+6.666)×(−0.1845λ+1.2861) [Equation 28]
(3.0411h−0.0604)×(−1.6718λ+2.3044)≤c₁(h,λ)≤(1.3111h+0.0125)×(−0.7034λ+2.0905) [Equation 29]
(6.1017h²−2.3528h+0.1599)×(0.6877λ+0.4574)≤a₂≤(3.7048h²−2.8283h+0.4455)×(−0.2401λ+1.3694) [Equation 30]
(0h³+143.3224h²−56.2086h+8.0672)×(−0.4138λ+1.3242)≤b₂(h,λ)≤(0h³+26.4708h²−22.3673h+7.4035)×(−0.0798λ+1.1237) [Equation 31]
(3.0010h−0.0060)×(−1.4116λ+2.1009)≤c₂(h,λ)≤(1.2941h+0.0668)×(−0.6424λ+1.9957) [Equation 32]

14. The rib waveguide with eliminated optical crosstalk of claim 13, wherein, when the plurality of optical waveguides comprise at least one of Li, Nb, or O, h ranges from 300 nm to 500 nm, and a wavelength λ ranges from 1.53 μm to 1.57 μm, the ai, bi, and ci are defined by the following Equation 33 to Equations 38, where i is 1 or 2:
a₁(h,λ)=(2.9703h²−2.3222h+0.3705)×(−0.4970λ+1.7703) [Equation 33]
b₁(h,λ)=(0h³+23.9640h²−20.0347h+6.666)×(−0.1845λ+1.2861) [Equation 34]
c₁(h,λ)=(1.3111h+0.0125)×(−0.7034λ+2.0905) [Equation 35]
a₂=(3.7048h²−2.8283h+0.4455)×(−0.2401λ+1.3694) [Equation 36]
b₂(h,λ)=(0h³+26.4708h²−22.3673h+7.4035)×(−0.0798λ+1.1237) [Equation 37]
c₂(h,λ)=(1.2941h+0.0668)×(−0.6424λ+1.9957) [Equation 38]

15. The rib waveguide with eliminated optical crosstalk of claim 13, wherein, when the plurality of optical waveguides comprise at least one of Li, Nb, or O, h ranges from 300 nm to 400 nm, and a wavelength λ ranges from 1.26 μm to 1.36 μm, the ai, bi, and ci are defined by the following Equation 39 to Equation 44, where i is 1 or 2:
a₁(h,λ)=(7.7562h²−5.3140h+0.8223)×(−0.5333λ+1.6978) [Equation 39]
b₁(h,λ)=(0h³−4.7840h²+3.5586h+1.8041)×(−0.2813λ+1.3706) [Equation 40]
c₁(h,λ)=(1.7453h−0.0584)×(−0.9183λ+2.2043) [Equation 41]
a₂(h,λ)=(9.1378h²−6.1766h+0.9451)×(−0.3027λ+1.3938) [Equation 42]
b₂(h,λ)=(0h³−5.9328h²+3.6708h+2.0987)×(−0.2055λ+1.2709) [Equation 43]
c₂(h,λ)=(1.6740h+0.0197)×(−0.8012λ+2.0505) [Equation 44]

16. The rib waveguide with eliminated optical crosstalk of claim 13, wherein when the plurality of optical waveguides comprise at least one of Li, Nb, or O, h ranges from 150 nm to 250 nm, and a wavelength λ ranges from 0.765 μm to 0.795 μm, the ai, bi, and ci are defined by the following Equation 45 to Equation 50 where i is 1 or 2:
a₁(h,λ)=(4.0903h²−1.5939h+0.0934)×(0.0310λ+0.9725) [Equation 45]
b₁(h,λ)=(0h³+144.7256h²−56.2606h+7.8288)×(−0.4214λ+1.3297) [Equation 46]
c₁(h,λ)=(3.0411h−0.0604)×(−1.6718λ+2.3044) [Equation 47]
a₂(h,λ)=(6.1017h²−2.3528h+0.1599)×(0.6877λ+0.4574) [Equation 48]
b₂(h,λ)=(0h³+143.3224h²−56.2086h+8.0672)×(−0.4138λ+1.3242) [Equation 49]
c₂(h,λ)=(3.0010h−0.0060)×(−1.4116λ+2.1009) [Equation 50]

17. The rib waveguide with eliminated optical crosstalk of claim 8, wherein when the plurality of optical waveguides comprise Si and N, h ranges from 200 nm to 600 nm, and a wavelength λ ranges from 0.76 μm to 1.57 μm, the ai, bi, and ci are defined by the following Equation 51 to Equation 56, where i is 1 or 2:
(0.9402h²−0.7537h+0.0459)×(−1.8027λ+2.4099)≤a₁(h,λ)≤(0.4882h²−0.6022h+0.1045)×(−0.7325λ+2.1352) [Equation 51]
(0h³+43.7154h²−26.5812h+6.3494)×(0.6160λ+0.5205)≤b₁(h,λ)≤(−54.3454h³+93.7517h²−55.2117h+13.3936)×(0.4589λ+0.2888) [Equation 52]
(1.1096h+0.2540)×(−0.6370λ+1.4969)≤c₁(h,λ)≤(0.5449h+0.2648)×(−0.3130λ+1.4852) [Equation 53]
(1.8940h²−1.2744h+0.1025)×(−2.3004λ+2.8001)≤a₂≤(0.7324h²−0.8781h+0.1751)×(−0.8580λ+2.3306) [Equation 54]
(0h³+40.1460h²−25.0287h+6.3345)×(0.5239λ+0.5927)≤b₂(h,λ)≤(−71.7281h³+121.2376h²−69.7364h+16.0803)×(0.5047λ+0.2177) [Equation 55]
(1.1140h+0.2798)×(−0.6273λ+1.4892)≤c₂(h,λ)≤(0.5688h+0.2779)×(−0.3019λ+1.4680) [Equation 56]

18. The rib waveguide with eliminated optical crosstalk of claim 17, wherein when the plurality of optical waveguides comprise Si and N, h ranges from 350 nm to 600 nm, and a wavelength λ ranges from 1.53 μm to 1.57 μm, the ai, bi, and ci are defined by the following Equation 57 to Equation 62, where i is 1 or 2:
a₁(h,λ)=(0.4882h²−0.6022h+0.1045)×(−0.7325λ+2.1352) [Equation 57]
b₁(h,λ)=(−54.3454h³+93.7517h²−55.2117h+13.3936)×(0.4589λ+0.2888) [Equation 58]
c₁(h,λ)=(0.5449h+0.2648)×(−0.3130λ+1.4852) [Equation 59]
a₂=(0.7324h²−0.8781h+0.1751)×(−0.8580λ+2.3306) [Equation 60]
b₂(h,λ)=(−71.7281h³+121.2376h²−69.7364h+16.0803)×(0.5047λ+0.2177) [Equation 61]
c₂(h,λ)=(0.5688h+0.2779)×(−0.3019λ+1.4680) [Equation 62]

19. The rib waveguide with eliminated optical crosstalk of claim 17, wherein when the plurality of optical waveguides comprise Si and N, h ranges from 300 nm to 500 nm, and a wavelength λ ranges from 1.26 μm to 1.36 μm, the ai, bi, and ci are defined by the following Equation 63 to Equation 68, where i is 1 or 2:
a₁(h,λ)=(0.5362h²−0.6056h+0.0826)×(−0.9016λ+2.1835) [Equation 63]
b₁(h,λ)=(−96.4897h³+136.1767h²−66.0737h+13.3296)×(0.4994λ+0.3464) [Equation 64]
c₁(h,λ)=(0.6397h+0.2660)×(−0.3627λ+1.4754) [Equation 65]
a₂=(1.0648h²−1.0616h+0.1691)×(−1.0307λ+2.3510) [Equation 66]
b₂(h,λ)=(−103.5869h³+142.8166h²−68.0991h+13.6835)×(0.4890λ+0.3601) [Equation 67]
c₂(h,λ)=(0.6654h+0.2812)×(−0.3644λ+1.4776) [Equation 68]

20. The rib waveguide with eliminated optical crosstalk of claim 17, wherein when the plurality of optical waveguides comprise Si and N, h ranges from 200 nm to 300 nm, and a wavelength λ ranges from 0.76 μm to 0.8 μm, the ai, bi, and ci are defined by the following Equation 69 to Equation 74, where i is 1 or 2:
a₁(h,λ)=(0.9402h²−0.7537h+0.0459)×(−1.8027λ+2.4099) [Equation 69]
b₁(h,λ)=(0h³+43.7154h²−26.5812h+6.3494)×(0.6160λ+0.5205) [Equation 70]
c₁(h,λ)=(1.1096h+0.2540)×(−0.6370λ+1.4969) [Equation 71]
a₂(h,λ)=(1.8940h²−1.2744h+0.1025)×(−2.3004λ+2.8001) [Equation 72]
b₂(h,λ)=(0h³+40.1460h²−25.0287h+6.3345)×(0.5239λ+0.5927) [Equation 73]
c₂(h,λ)=(1.1140h+0.2798)×(−0.6273λ+1.4892) [Equation 74]

21. The rib waveguide with eliminated optical crosstalk of claim 8, wherein when the plurality of optical waveguides comprise at least one of Li, Ta or O, h ranges from 300 nm to 500 nm, and a wavelength λ ranges from 1.26 μm to 1.57 μm, the ai, bi, and ci are defined by the following Equation 75 to Equation 80, where i is 1 or 2:
(−0.5282h²−0.4074h+0.0750)×(−1.6357λ+3.5388)≤a₁(h,λ)≤(7.2287h²−5.5571h+0.9227)×(−1.8058λ+3.3663) [Equation 75]
(6.9131h³+14.9322h²−18.9589h+6.9147)×(0.3166λ+0.5093)≤b₁(h,λ)≤(0h³−11.5154h²+4.2365h+2.0228)×(0.3142λ+0.5885) [Equation 76]
(0.4820h+0.2100)×(−0.2732λ+1.4235)≤c₁(h,λ)≤(0.7150h+0.1745)×(−0.3925λ+1.5146) [Equation 77]
(−0.0867h²−0.8051h+0.1380)×(−1.6950λ+3.6309)≤a₂≤(9.3541h²−7.0438h+1.1602)×(−1.7683λ+3.3174) [Equation 78]
(18.3740h³+1.5265h²−14.1741h+6.5985)×(0.2961λ+0.5413)≤b₂(h,λ)≤(0h³−9.5687h²+2.3057h+2.6414)×(0.3406λ+0.5538) [Equation 79]
(0.6238h+0.2060)×(−0.3070λ+1.4756)≤c₂(h,λ)≤(0.8353h+0.1823)×(−0.4180λ+1.5481) [Equation 80]

22. The rib waveguide with eliminated optical crosstalk of claim 21, wherein when the plurality of optical waveguides comprise at least one of Li, Ta, or O, h ranges from 300 nm to 500 nm, and a wavelength λ ranges from 1.53 μm to 1.57 μm, the ai, bi, and ci are calculated based on the following Equation 81 to Equation 86, where i is 1 or 2:
a₁(h,λ)=(−0.5282h²−0.4074h+0.0750)×(−1.6357λ+3.5388) [Equation 81]
b₁(h,λ)=(6.9131h³+14.9322h²−18.9589h+6.9147)×(0.3166λ+0.5093) [Equation 82]
c₁(h,λ)=(0.4820h+0.2100)×(−0.2732λ+1.4235) [Equation 83]
a₂(h,λ)=(−0.0867h²−0.8051h+0.1380)×(−1.6950λ+3.6309) [Equation 84]
b₂(h,λ)=(18.3740h³+1.5265h²−14.1741h+6.5985)×(0.2961λ+0.5413) [Equation 85]
c₂(h,λ)=(0.6238h+0.2060)×(−0.3070λ+1.4756) [Equation 86]

23. The rib waveguide with eliminated optical crosstalk of claim 21, wherein when the plurality of optical waveguides comprise at least one of Li, Ta or O, h ranges from 300 nm to 400 nm, and a wavelength λ ranges from 1.26 μm to 1.36 μm, the ai, bi, and ci are defined by the following Equation 87 to Equation 92, where i is 1 or 2:
a₁(h,λ)=(7.2287h²−5.5571h+0.9227)×(−1.8058λ+3.3663) [Equation 87]
b₁(h,λ)=(0h³−11.5154h²+4.2365h+2.0228)×(0.3142λ+0.5885) [Equation 88]
c₁(h,λ)=(0.7150h+0.1745)×(−0.3925λ+1.5146) [Equation 89]
a₂=(9.3541h²−7.0438h+1.1602)×(−1.7683λ+3.3174) [Equation 90]
b₂(h,λ)=(0h³−9.5687h²+2.3057h+2.6414)×(0.3406λ+0.5538) [Equation 91]
c₂(h,λ)=(0.8353h+0.1823)×(−0.4180λ+1.5481) [Equation 92]

24. The rib waveguide with eliminated optical crosstalk of claim 8, wherein when the plurality of optical waveguides comprise at least one of Ba, Ti, or O, h ranges from 200 nm to 500 nm, and a wavelength λ ranges from 1.26 μm to 1.57 μm, the ai, bi, and ci are defined by the following Equation 93 to Equation 98, where i is 1 or 2:
(−0.5113h²−0.0697h+0.0026)×(−2.0302λ+4.1441)≤a₁(h,λ)≤(12.2501h²−9.1733h+1.5302)×(−1.8778λ+3.4656) [Equation 93]
(0h³−20.2498h²−18.8865h+6.2122)×(0.1569λ+0.7563)≤b₁(h,λ)≤(0h³−23.5823h²+13.5943h+0.1429)×(0.1419λ+0.8156) [Equation 94]
(0.6112h+0.1533)×(−0.3951λ+1.6125)≤c₁(h,λ)≤(0.8689h+0.0973)×(−0.4900λ+1.6421) [Equation 95]
(0.2377h²−0.7678h+0.1315)×(−1.4150λ+3.1953)≤a₂≤(15.8959h²−11.6936h+1.9322)×(−1.7315λ+3.2714) [Equation 96]
(0h³+18.4494h²−17.7013h+6.2640)×(0.3303λ+0.4886)≤b₂(h,λ)≤(0h³−21.7569h²+11.7518h+0.7363)×(0.2032λ+0.7351) [Equation 97]
(0.7126h+0.1641)×(−0.4156λ+1.6441)≤c₂(h,λ)≤(0.9799h+0.1199)×(−0.4912λ+1.6435) [Equation 98]

25. The rib waveguide with eliminated optical crosstalk of claim 24, wherein when the plurality of optical waveguides comprise at least one of Ba, Ti, or O, h ranges from 300 nm to 500 nm, and a wavelength λ ranges from 1.53 μm to 1.57 μm, the ai, bi, and ci are defined by the following Equation 99 to Equation 104, where i is 1 or 2:
a₁(h,λ)=(−0.5113h²−0.0697h+0.0026)×(−2.0302λ+4.1441) [Equation 99]
b₁(h,λ)=(0h³−20.2498h²−18.8865h+6.2122)×(0.1569λ+0.7563) [Equation 100]
c₁(h,λ)=(0.6112h+0.1533)×(−0.3951λ+1.6125) [Equation 101]
a₂(h,λ)=(0.2377h²−0.7678h+0.1315)×(−1.4150λ+3.1953) [Equation 102]
b₂(h,λ)=(0h³+18.4494h²−17.7013h+6.2640)×(0.3303λ+0.4886) [Equation 103]
c₂(h,λ)=(0.7126h+0.1641)×(−0.4156λ+1.6441) [Equation 104]

26. The rib waveguide with eliminated optical crosstalk of claim 24, wherein when the plurality of optical waveguides comprise at least one of Ba, Ti, or O, h ranges from 300 nm 400 nm, and a wavelength λ ranges from 1.26 μm to 1.36 μm, the ai, bi, and ci are defined by the following Equation 105 to Equation 110, where i is 1 or 2:
a₁(h,λ)=(12.2501h²−9.1733h+1.5302)×(−1.8778λ+3.4656) [Equation 105]
b₁(h,λ)=(0h³−23.5823h²+13.5943h+0.1429)×(0.1419λ+0.8156) [Equation 106]
c₁(h,λ)=(0.8689h+0.0973)×(−0.4900λ+1.6421) [Equation 107]
a₂=(15.8959h²−11.6936h+1.9322)×(−1.7315λ+3.2714) [Equation 108]
b₂(h,λ)=(0h³−21.7569h²+11.7518h+0.7363)×(0.2032λ+0.7351) [Equation 109]
c₂(h,λ)=(0.9799h+0.1199)×(−0.4912λ+1.6435) [Equation 110]
